(19) United States
(12) Patent Application Publication
(10) Pub. No.: US 2026/0244287 A1
(43) Pub. Date: Aug. 20, 2026

(54) CONTROLLER

(71) Applicant: Razer (Asia-Pacific) Pte. Ltd., Singapore (SG)

(72) Inventors: Gil Jr Palma GUERRERO, Singapore (SG); Weijie CAI, Singapore (SG); Yujin HWANG, Irvine, CA (US)

(73) Assignee: Razer (Asia-Pacific) Pte. Ltd., Singapore (SG)

(21) Appl. No.: 19/162,069

(22) PCT Filed: Mar. 16, 2023
(86) PCT No.: PCT/SG2023/050170

§ 371 Date: Sep. 4, 2025

(51) Int. Cl. G06F 3/039; A63F 13/235; A63F 13/24; A63F 13/98

(52) U.S. Cl. CPC G06F 3/039; A63F 13/24; A63F 13/98; A63F 13/235; A63F 2300/8082

(57) ABSTRACT

According to various embodiments, there may be provided a controller. The controller may include a controller body. The controller body may include a main portion, and a handle portion extending from the main portion. The controller may further include one or more control elements arranged at a control surface of the main portion. Further, the controller may include a strap adjustment mechanism at a side of the controller body. The strap adjustment mechanism may include a movable tab that is movable between a first position proximal to the control surface of the main portion of the controller body and a second position distal from the control surface of the main portion of the controller body.

### TECHNICAL FIELD

Embodiments generally relate to a controller, and particularly to a controller for an electronic device. In particular, a controller for Virtual Reality (VR) applications to interact with the virtual world.

### BACKGROUND

Various hand-held devices generally come with a strap for securing to a user's arm or wrist. For example, wrist straps may be provided for hand-held cameras.

To ensure that such conventional straps are capable of fitting different sized arms or wrists of different users, some of these conventional straps may be made of an elastic band. Other conventional straps may include a buckle through which the strap passes, for adjusting a length of the strap.

However, with straps made of an elastic band, the elastic band tends to lose its elasticity with use over time. On the other hand, adjusting a length of a strap with a buckle is a time-consuming and tedious process, which typically requires a user to adjust with both hands before fitting on.

In addition to the above-mentioned issues, straps for many hand-held devices are generally difficult and time-consuming to fix on or remove. As such, many users tend to leave the straps attached to their hand-held devices for long durations, which tend to accumulate dirt and bacteria.

Therefore, there may be a need for a hand-held device (e.g. a controller for an electronic device) with improved strap arrangement and/or attachment mechanism which solves at least the above-mentioned issues.

### SUMMARY

According to various embodiments, there may be provided a controller. The controller may include a controller body. The controller body may include a main portion, and a handle portion extending from the main portion. The controller may include one or more control elements arranged at a control surface of the main portion. Further, the controller may include a strap adjustment mechanism at a side of the controller body. The strap adjustment mechanism may include a movable tab that is movable between a first position proximal to the control surface of the main portion of the controller body and a second position distal from the control surface of the main portion of the controller body.

According to various embodiments, there may be provided a controller. The controller may include a controller body. The controller body may include a strap-receiving bay extending from a side of the controller body into the controller body. The strap-receiving bay may have an insertion axis. A strap for the controller body may be insertable into the strap-receiving bay along the insertion axis. The controller may further include a strap engagement mechanism. The strap engagement mechanism may include a displacement member with a strap-latching portion. The displacement member may be disposed relative to the strap-receiving bay in a manner to be movable along a movement axis, the movement axis being non-parallel to the insertion axis of the strap-receiving bay, between a first position and a second position. Moving the displacement member from the second position to the first position may move the strap-latching portion of the displacement member into the strap-receiving bay. On the other hand, moving the displacement member from the first position to the second position may move the strap-latching portion of the displacement member out of the strap-receiving bay. The displacement member may further include an engageable element configured to receive an external force to move the displacement member along the movement axis.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various embodiments are described with reference to the following drawings.

FIG. 1A shows a perspective view of a controller, according to various embodiments;

FIG. 1B shows a close-up view of a movable tab of a strap adjustment mechanism of the controller, according to various embodiments;

FIG. 1C shows a close-up view of a tab-guide of the controller, with a movable tab of the strap adjustment mechanism cooperatively engaged with the tab-guide, according to various embodiments;

FIG. 1D shows a side view of FIG. 1C, with the movable tab cooperatively engaged with the tab-guide, according to various embodiments;

FIG. 1E shows an exploded view of the tab-guide, with the movable tab disengaged from the tab-guide, according to various embodiments;

FIG. 1F shows a top view of the tab-guide secured to the controller body, according to various embodiments;

FIG. 1G shows an exploded view of an attachment element of a strap attachment arrangement of the controller, according to various embodiments;

FIG. 2A and FIG. 2B show schematic diagrams of a strap being removably coupled to a controller body, according to various embodiments;

FIG. 2C to FIG. 2E show perspective views of a controller depicting a sequence of removing a strap from a controller body of the controller, according to various embodiments;

FIG. 2F is an internal view of the controller body of the controller of FIG. 2C, revealing a strap engagement mechanism to removably receive the strap, according to various embodiments;

FIG. 2G and FIG. 2H are top views of the strap engagement mechanism of FIG. 2F; and

FIG. 2I and FIG. 2J are perspective bottom views of the strap engagement mechanism of FIG. 2G and FIG. 2H.

### DETAILED DESCRIPTION

Embodiments described below in context of the apparatus are analogously valid for the respective methods, and vice versa. Furthermore, it will be understood that the embodiments described below may be combined, for example, a part of one aspect may be combined with a part of another aspect.

It should be understood that the terms “on”, “over”, “top”, “bottom”, “down”, “side”, “back”, “left”, “right”, “front”, “lateral”, “up” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

Various embodiments generally relate to a controller (e.g. a hand-held device, a hand-held input device, a peripheral input device, etc.) which includes a strap adjustment mechanism that is simple to operate for adjusting a length, size, shape, or tautness, etc., of a strap for the controller. More particularly, a strap may be releasably attached to the controller to form a loop, and a tautness of the strap may be adjusted by the user of the controller (e.g. with merely one hand of the user, in a single movement of the user's hand) via the strap adjustment mechanism of the controller.

The strap adjustment mechanism may include a movable portion (e.g. a movable tab) to which one end of the strap may be attachable. Another end of the strap may be optionally attachable, for example, to a handle portion of the controller body of the controller itself. The movable portion may then be movable in a general “up” or “down” direction with respect to (e.g. towards or away from) one or more input-receiving elements (or control elements, e.g. buttons, touch-screen, etc.) of the controller. In this configuration of the movable portion (e.g. the movable tab), movable in said general “up” or “down” direction, the controller may have a compact form factor (e.g. made small and/or short, as opposed to being long in a longitudinal or elongate direction).

To releasably hold the movable portion at a desired position (selectable from among a plurality of predetermined positions) relative to the controller body, the movable portion may be held between a clamp member (e.g. at least two arms of a tab-guide) of the controller. Additionally, the clamp member may include a property of being resilient and/or may be pivotable about one end thereof to facilitate movement of the movable portion as the movable portion is moved along said clamp member.

In various other embodiments, the controller may include two or more strap adjustment mechanisms with two or more movable portions. A user may then selectively releasably attach a strap to any one of the two or more movable portions of the two or more strap adjustment mechanisms of such a controller, according to various other embodiments.

Additionally, various embodiments may relate to a controller which includes an attachment mechanism (e.g. a strap engagement mechanism) for fast and/or simple attachment or removal of a strap for a controller from a controller body of the controller.

The controller body may include (or define) an internal receptacle space (e.g. a strap-receiving bay) extending inwards of the controller body from a side of the controller body. The attachment mechanism of the controller may include a movable member (e.g. a displacement member) that is movably disposed (e.g. slidable) relative to the internal receptacle space. When the strap for the controller is inserted (e.g. a portion of the strap is entirely inserted) into the internal receptacle space, the movable member may be moved into (e.g. at least partially into) the internal receptacle space to engage (or abut) the strap, thereby “catching” the strap to secure it within the internal receptacle space of the controller body. To remove the strap from the internal receptacle space, the movable member may be moved out and/or away from the internal receptacle space. Without the movable member touching or interfering with (i.e. engaging or abutting) the strap within the internal receptacle space, the strap may be freely movable relative to, and for removal out of, the controller body.

Moving the movable member relative to said internal receptacle space may be achieved by probing a tool (e.g. a pin, needle, eject pin/tool, etc.) into the controller body to engage and/or push against a force-receiving segment (e.g. an engageable element) of the movable member. In other words, the force-receiving segment may be configured to receive an external force to move or for moving the movable member.

The following Examples pertain to various embodiments.

Example 1 is a controller. The controller may include a controller body. The controller body may include a main portion, and a handle portion extending from the main portion. The controller may further include one or more control elements arranged at a control surface of the main portion. Further, the controller may include a strap adjustment mechanism at a side of the controller body. The strap adjustment mechanism may include a movable tab that is movable between a first position proximal to the control surface of the main portion of the controller body and a second position distal from the control surface of the main portion of the controller body.

In Example 2, the subject matter of Example 1 may optionally include a strap; wherein the controller body further includes a strap attachment arrangement for releasably attaching the strap to the controller body; wherein the strap attachment arrangement includes an attachment element at the movable tab of the strap adjustment mechanism; wherein the strap is releasably attached to the controller body via the strap attachment arrangement, with a first end of the strap releasably attached to the attachment element at the movable tab, to form a loop with the controller body; and wherein, moving the movable tab between the first position and the second position changes a tautness of the strap releasably attached to the controller body.

In Example 3, the subject matter of Example 2 may optionally include wherein the strap attachment arrangement further includes a further attachment element at the handle portion of the controller body; and wherein the strap is releasably attached to the controller body via the strap attachment arrangement, with a second end of the strap, opposite the first end of the strap, releasably attached to the further attachment element at the handle portion in a manner to form the loop with the controller body.

In Example 4, the subject matter of any one of Examples 1 to 3 may optionally include wherein the strap adjustment mechanism includes a tab-guide which defines a linear pathway for the movable tab to be movable therealong.

In Example 5, the subject matter of Example 4 may optionally include wherein the control surface is a substantially flat surface; and wherein the linear pathway defined by the tab-guide is substantially perpendicular to the control surface.

In Example 6, the subject matter of Example 4 may optionally include wherein the movable tab includes a first engagement arrangement; wherein the tab-guide includes a second engagement arrangement; and wherein the first engagement arrangement and the second engagement arrangement are configured to inter-engage with each other for releasably holding the movable tab in place relative to the tab-guide.

In Example 7, the subject matter of Example 6 may optionally include wherein the first engagement arrangement includes at least one first engagement element; wherein the second engagement arrangement includes a plurality of second engagement elements configured to inter-engage with the first engagement element, the plurality of second engagement elements including a first sub-set of second engagement elements disposed at a first region of the tab-guide corresponding to the first position proximal to the control surface of the main portion of the controller body, and a second sub-set of second engagement elements disposed at a second region of the tab-guide corresponding to the second position distal from the control surface of the main portion of the controller body.

In Example 8, the subject matter of Example 7 may optionally include wherein the plurality of second engagement elements further include a further sub-set of second engagement elements disposed at an intermediate region, between the first region and the second region, of the tab-guide.

In Example 9, the subject matter of any one of Examples 6 to 8 may optionally include wherein the first engagement arrangement and the second engagement arrangement include inter-engageable protrusion and recess or inter-engageable magnetic couplings.

In Example 10, the subject matter of any one of Examples 4 to 10 may optionally include wherein the tab-guide includes a main member with at least two opposing arms, wherein the at least two opposing arms extend in a parallel manner to define the linear pathway; wherein the movable tab is movable along the linear pathway between the at least two opposing arms.

In Example 11, the subject matter of Example 1 may optionally include wherein the strap adjustment mechanism includes a tab-guide which defines a linear pathway for the movable tab to be movable therealong; wherein the tab-guide includes a main member with at least two opposing arms, wherein the at least two opposing arms extend in a parallel manner to define the linear pathway; wherein the movable tab is movable along the linear pathway between the at least two opposing arms; wherein the movable tab includes a first engagement element; wherein the tab-guide includes a plurality of second engagement elements configured to inter-engage with the first engagement element; wherein the plurality of second engagement elements are distributed lengthwise along an inner surface of each of the at least two opposing arms.

In Example 12, the subject matter of Example 10 or Example 11 may optionally include wherein the main member of the tab-guide includes a bridge segment connecting the at least two opposing arms, wherein each arm of the at least two opposing arms is affixed to the bridge segment at a first end portion of the arm member, and wherein a second free end portion, opposite the first end portion, of each arm is resiliently displaceable with respect to the first end portion.

In Example 13, the subject matter of any one of Examples 10 to 12 may optionally include wherein the tab-guide includes an auxiliary member with at least one alignment rod extending along a direction substantially parallel with the linear pathway; wherein the movable tab defines at least one bore; wherein the at least one alignment rod is extending through the at least one bore of the movable tab.

In Example 14, the subject matter of Example 13 may optionally include wherein the at least one alignment rod is between the at least two opposing arms.

In Example 15, the subject matter of any one of Examples 1 to 14 may optionally include wherein the handle portion and the main portion of the controller body are integrally formed.

In Example 16, the subject matter of any one of Examples 4 to 15 may optionally include wherein the handle portion is elongate and is arranged such that a longitudinal axis of the handle portion is extending non-perpendicularly to the linear pathway.

In Example 17, the subject matter of Example 16 may optionally include wherein the handle portion extends diagonally downwardly and away from the control surface of the main portion of the controller body.

In Example 18, the subject matter of any one of Examples 1 to 17 may optionally include wherein the movable tab is at least partially housed within the controller body via the opening.

Example 19 is a controller. The controller may include a controller body. The controller body may include a strap-receiving bay extending from a side of the controller body into the controller body. The strap-receiving bay may have an insertion axis. A strap for the controller body may be insertable into the strap-receiving bay along the insertion axis. The controller may further include a strap engagement mechanism. The strap engagement mechanism may include a displacement member with a strap-latching portion. The displacement member may be disposed relative to the strap-receiving bay in a manner to be movable along a movement axis, the movement axis being non-parallel to the insertion axis of the strap-receiving bay, between a first position and a second position. Moving the displacement member from the second position to the first position may move the strap-latching portion of the displacement member into the strap-receiving bay. On the other hand, moving the displacement member from the first position to the second position may move the strap-latching portion of the displacement member out of the strap-receiving bay. The displacement member may further include an engageable element configured to receive an external force to move the displacement member along the movement axis.

In Example 20, the subject matter of Example 19 may optionally include wherein the strap-latching portion includes a latching-surface, the latching-surface serving as a stopper against a portion of the strap to prevent the strap from slipping out of the strap-receiving bay, when the strap is inserted into the strap-receiving bay and when the displacement member is at the first position.

In Example 21, the subject matter of Example 19 or Example 20 may optionally include wherein the latching-surface is oriented to face inwards of the controller body with respect to the insertion axis.

In Example 22, the subject matter of Example 20 or Example 21 may optionally include wherein the strap-latching portion is formed as an elongate portion protruding from a main body of the displacement member, with the latching-surface being on a side of the strap-latching portion.

In Example 23, the subject matter of any one of Examples 19 to 22 may optionally include wherein the strap-latching portion is moved into a side region of the strap-receiving bay when the displacement member is moved to the first position.

In Example 24, the subject matter of any one of Examples 19 to 23 may optionally include wherein the strap-latching portion includes a sliding-surface to which the strap engages when strap is inserted into the strap-receiving bay, the sliding-surface being inclined with respect to the insertion axis and is oriented to face outwards of the controller body.

In Example 25, the subject matter of any one of Examples 19 to 24 may optionally include wherein the engageable element is a surface of the displacement member that is inclined with respect to the insertion axis and faces in a direction outwards of the controller body with respect to the insertion axis.

In Example 26, the subject matter of any one of Examples 19 to 25 may optionally include wherein the controller body includes an access interface on the side of the controller body for applying the external force to the engageable element of the displacement member.

In Example 27, the subject matter of any one of Examples 19 to 26 may optionally include that the controller may further include a plunger member disposed relative to the displacement member and cooperatively coupled with the engageable element of the displacement member to be capable of transmitting the external force to the engageable element of the displacement member when the external force is applied to the plunger member.

In Example 28, the subject matter of Example 27 may optionally include wherein the plunger member includes an end portion with an end surface that is inclined with respect to the movement axis and that is oriented to face inwards of the controller body with respect to the insertion axis, said end surface of the plunger member in sliding engagement with the engageable element of the displacement member to cooperatively couple the plunger member and the displacement member.

In Example 29, the subject matter of Example 28 may optionally include wherein the end surface of the plunger member and the engageable element of the displacement member slide against each other as the external force is applied to the plunger member and transmitted to the displacement member.

In Example 30, the subject matter of any one of Examples 27 to 29 may optionally include wherein the plunger member is movable along a non-parallel direction to the movement axis.

In Example 31, the subject matter of Example 30 may optionally include wherein the plunger is movable along a direction perpendicular to the movement axis.

In Example 32, the subject matter of any one of Examples 19 to 31 may optionally include wherein the controller body includes an internal guide structure affixed to an outer housing of the controller body, the internal guide structure configured to guide the displacement member to be movable along the movement axis.

In Example 33, the subject matter of Example 32 may optionally include wherein the internal guide structure includes a guide element extending along the movement axis, wherein the displacement member is in sliding engagement with the guide element so that the displacement member is guided by the guide element of the internal guide structure to be movable along the movement axis.

In Example 34, the subject matter of Example 33 may optionally include wherein the guide element includes a guide-channel that constraints the displacement member to be movable along the movement axis.

In Example 35, the subject matter of any one of Examples 19 to 34 may optionally include that the controller may further include a biasing member coupled to the controller body and to the displacement member in a manner such that the displacement member, when moved to second position from the first position, causes the biasing member to be resiliently deformed to thereby exert a biasing force on the displacement member to urge the displacement member towards the first position.

In Example 36, the subject matter of any one of Examples 19 to 35 may optionally include that the controller may further include a strap-ejection mechanism which may include a resilient arrangement, wherein at least a portion of the resilient arrangement is within the strap-receiving bay when the strap-receiving bay is free of the strap and is resiliently deformed towards the controller body, when the strap is inserted into the strap-receiving bay, to thereby exert a biasing force on the strap to urge the strap away from the controller body.

In Example 37, the subject matter of any one of Examples 19 to 36 may optionally include that the controller may further include the strap inserted into the strap-receiving bay, wherein, when the displacement member is moved to the first position, the strap-latching portion of the displacement member is moved into the strap-receiving bay to latch against an engagement-portion of the strap within the strap-receiving bay to thereby prevent the strap from moving out of the strap-receiving bay.

In Example 38, the subject matter of Example 37 may optionally include that wherein the engagement-portion of the strap includes a notch extending inwardly from a longitudinal side of the strap, wherein when the displacement member is at the first position, the strap-latching portion of the displacement member is seated within the notch of the strap to prevent longitudinal movement of the strap along the insertion axis.

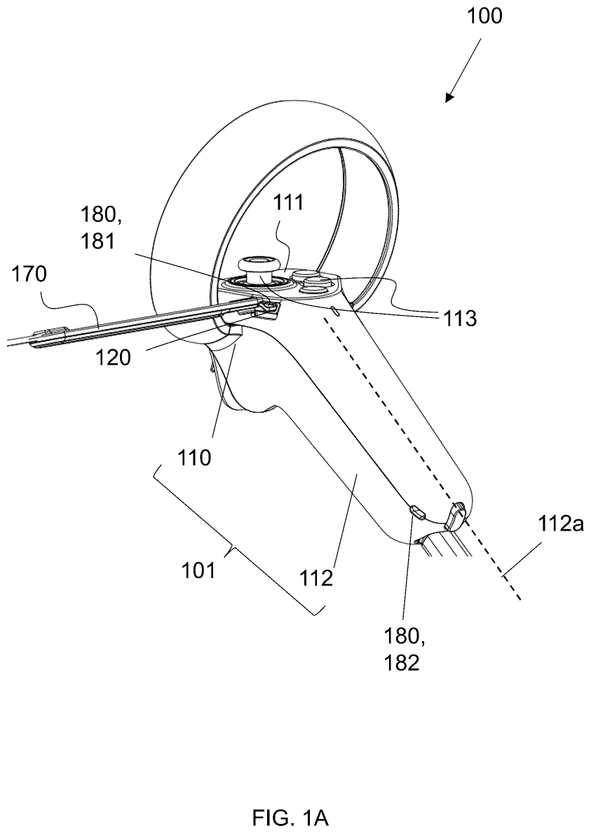

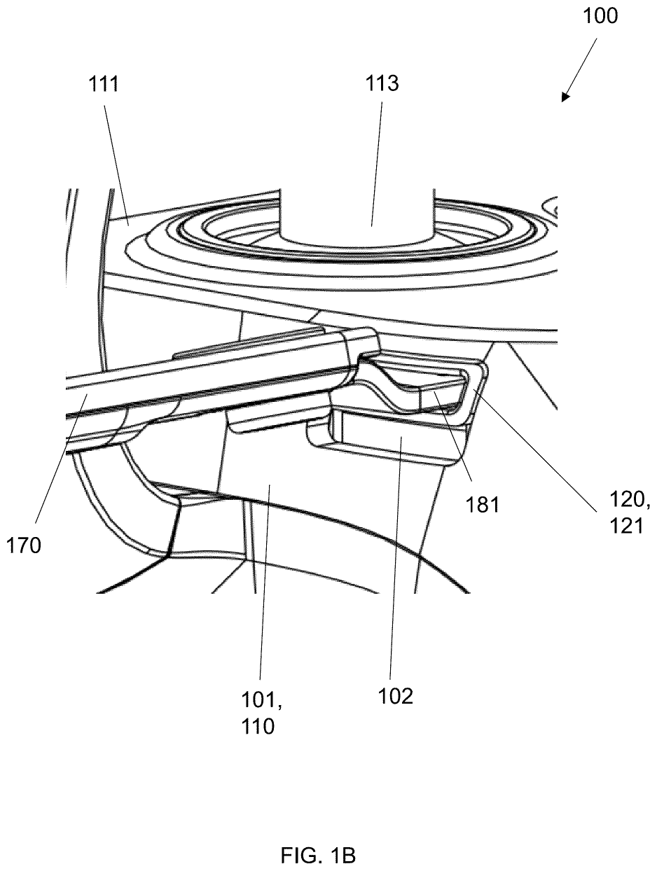

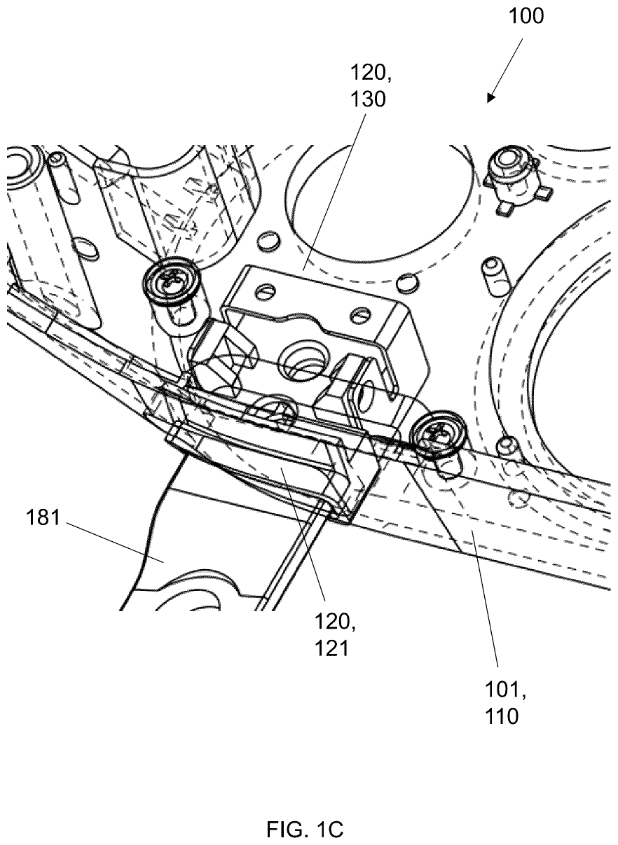

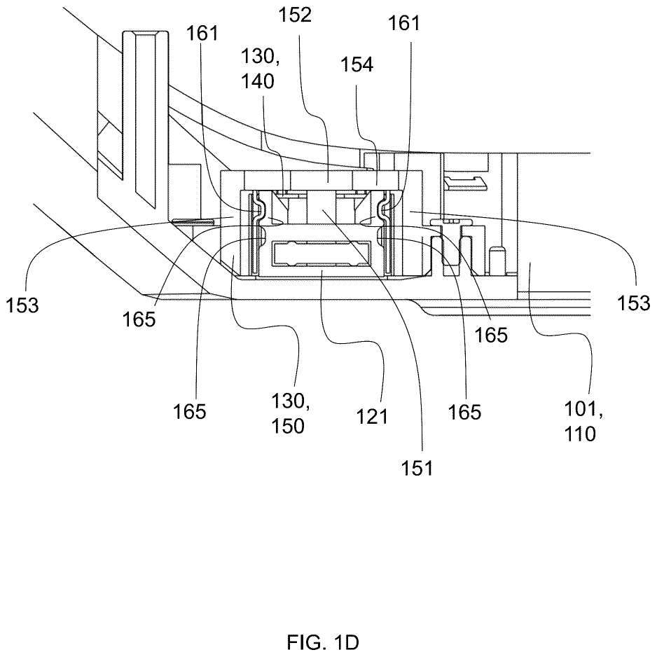

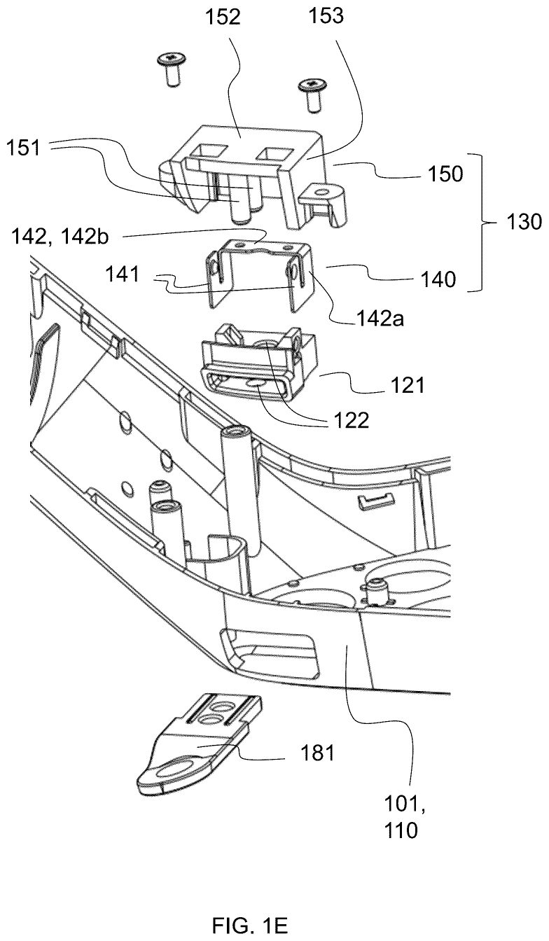

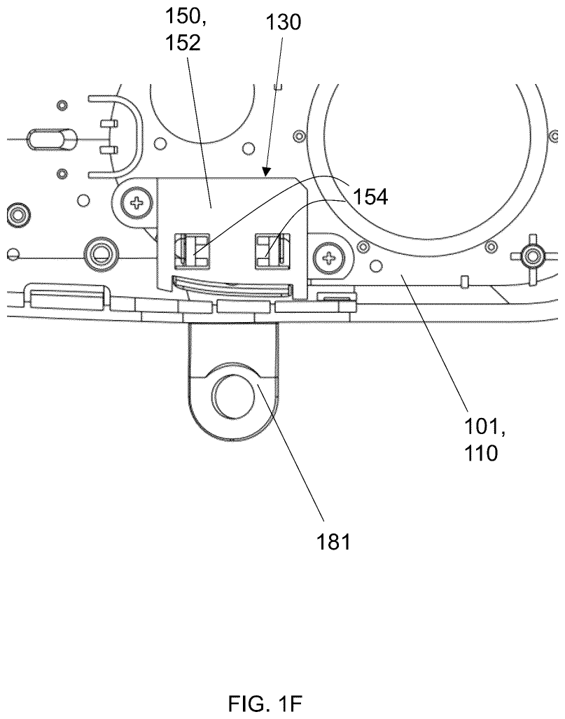

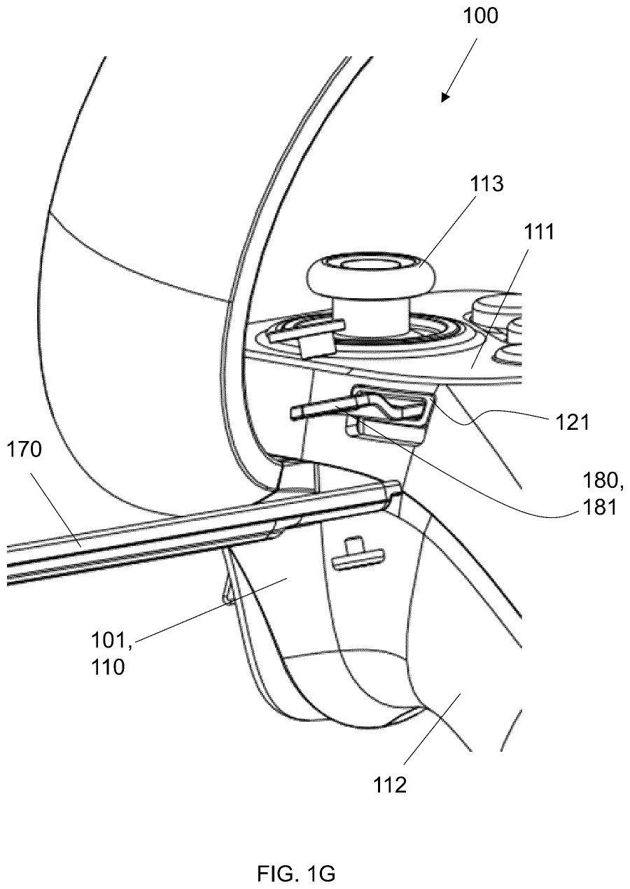

FIG. 1A shows a perspective view of a controller 100, according to various embodiments.

According to various embodiments, there may be provided the controller 100. The controller 100 may be for or configured for an electronic device. As such, the controller 100 may be paired with an electronic device, for example, via a wired connection, or a wireless connection, such as Bluetooth, internet, Wi-Fi, etc. The electronic device may be or may include, for example, a virtual reality console, an augmented reality console, or any other type of console or system. Accordingly, when the electronic device is a virtual reality console, the controller 100 may be a virtual reality controller configured to or for controlling a virtual reality (VR) application (e.g. a VR game) running on the virtual reality console. Hence, the controller 100 may allow the user to interact with the virtual world. As other non-limiting examples, according to various other embodiments, the electronic device may be or may include, for example, a laptop, a computer, a television, a monitor, a projector, an appliance (e.g. smart home appliance), or any electronic gadget, or a vehicle (e.g. an unmanned vehicle, e.g. an unmanned aerial vehicle). Accordingly, when the electronic device is an electronic gadget or a vehicle, the controller 100 may be configured to control (e.g. operate) the electronic gadget or the vehicle.

With reference to FIG. 1A, the controller 100 may include a controller body 101. The controller body 101 may be a chassis, an outer case, etc., of the controller 100, which may define an inner space for housing or encasing one or more components (e.g. mechanical and/or electronic components) of the controller 100. As shown in FIG. 1A, the controller body 101 may include a main portion 110 (which may be referred to as “a head portion”) and a handle portion 112 extending from the main portion 110.

The main portion 110 (e.g. head portion) of the controller body 101 may include a control surface 111. Specifically, the control surface 111 may be an upward-facing surface, when the controller 100 is in an upright or “use” orientation as shown in FIG. 1A. According to various embodiments, the control surface 111 may be a flat or level surface.

The handle portion 112 of the controller body 101 may be, but is not limited to being, integral or integrally formed with the main portion 110 of the controller body 101. As shown in FIG. 1A, the handle portion 112 may be elongate and/or straight (i.e. along a longitudinal axis 112a of the handle portion 112) for a user of the controller 100 to hold or grip the controller 100 thereby. According to various embodiments, the handle portion 112 may be arranged in a non-parallel manner with respect to the main portion 110 of the controller body 101. Specifically, the longitudinal axis 112a of the handle portion 112 may be non-parallel with respect to the control surface 111 (e.g. a flat control surface 111) of the main portion 110 of the controller body 101. For example, as shown in FIG. 1A, according to various embodiments, the handle portion 112 may be extending diagonally downwardly (e.g. diagonally downwardly and away/outwardly) from the control surface 111 of the main portion 110 of the controller body 101. As another example (not shown), according to various other embodiments, the handle portion 112 may be extending perpendicularly (e.g. downwardly) from the control surface 111 of the main portion 110.

As shown in FIG. 1A, the controller 100 may include one or more control elements 113 at (e.g. arranged at or distributed along), and/or exposed from, the control surface 111 (e.g. the upward-facing surface) of the main portion 110 of the controller body 101. The one or more control elements 113 of the controller 100 may be capable of receiving an input from a user of the controller 100. For example, the one or more control elements 113 may include or may be any one or more of: a touch screen, push button(s), directional pad, thumb stick(s), joystick(s), analog stick(s), sensor(s) (e.g. gesture recognition sensor(s)) or any other type of control element(s). Accordingly, the user of the controller 100 may operate or manipulate (e.g. touch, push, roll, hover/gesture over or towards, etc.) the one or more control elements 113 at the control surface 111 of the controller body 101 to control the electronic device (i.e. to which the controller 100 may be connected) and/or to manipulate an application or software (e.g. a virtual reality application or game) running on the electronic device. According to various embodiments, the one or more control elements 113 at the control surface 111 of the main portion 110 of the controller body 101 may be arranged to be reachable or accessible by the user's thumb when the user is holding or griping the controller 100 by the handle portion 112 of the controller body 101. As such, the one or more control elements 113 may serve as one or more thumb-operable control elements 113.

FIG. 1B shows a close-up view of a movable tab 121 of a strap adjustment mechanism 120 of the controller 100, according to various embodiments.

According to various embodiments, the controller 100 may include (e.g. further include) the strap adjustment mechanism 120. As shown, the strap adjustment mechanism 120 may be at a side (e.g. a left side, or a right side) of the controller body 101 and may include the movable tab 121 to which a strap 170 may be attached. Specifically, at least a portion of the strap adjustment mechanism 120 (e.g. at least the movable tab 121 of the strap adjustment mechanism 120) or the entire strap adjustment mechanism 120 itself may be at the main portion 110 (e.g. head portion) of the controller body 101. According to various embodiments, the movable tab 121 (e.g. entire movable tab 121) of the strap adjustment mechanism 120 may be (or remain) at a region of a side of the main portion 110 of the controller body 101 below or underneath the control surface 111 of the main portion 110 of the controller body 101 (e.g. in an assembled controller 100). The movable tab 121 of the strap adjustment mechanism 120 may be movable relative to the controller body 101 between a first position (or first location) proximal (or near or nearer) to the control surface 111 of the main portion 110 of the controller body 101 and a second position (or second location) distal (or far or further away) from the control surface 111 of the main portion 110 of the controller body 101. Said differently, the movable tab 121 of the strap adjustment mechanism 120 may be movable in at least two opposite directions, of which a first direction is directed away from the control surface 111 (e.g. along the side of the controller body 101 in a direction to increase a distance from the control surface 111) and a second direction is directed towards or is approaching the control surface 111 (e.g. along the side of the controller body 101 in a direction to reduce a distance from the control surface 111) of the main portion 110 of the controller body 101. A pathway along which the movable tab 121 may be movable (i.e. between the first position and the second position) may be a straight pathway. Said straight pathway may be perpendicular to the control surface 111 (e.g. a flat control surface 111). In other words, the strap adjustment mechanism 120 may be configured such that movement of the movable tab 121 may follow or may be along a straight line or movement axis. According to various embodiments, when the strap 170 is attached to the controller body 101 to form a loop, moving the movable tab 121 between the first position and the second position may adjust or change a tautness of the strap 170 relative to the controller body 101. In other words, the strap adjustment mechanism 120 may be configured to or may be for adjusting or changing a tautness of the strap 170 attached to the controller body 101. To illustrate, when a first end of the strap 170 is fixed to the controller body 101, e.g. at a tip of the handle portion 112, and the second end of the strap 170 is attached to the movable tab 121 of the strap adjustment mechanism 120 to form a loop with the controller body 101, moving the movable tab 121 to the first position (i.e. proximal or nearer to the control surface 111) may cause the strap 170 to become taut (or more taut), since the strap 170 (or the second end of the strap 170) is stretched away from the first end of the strap 170 that is fixed to the controller body 101, e.g. the tip of the handle portion 112. On the other hand, moving the movable tab 121 to the second position (i.e. distal or further from the control surface 111 than the first position) may cause the strap 170 to become less taut (or looser), since the second end of the strap 170 at the movable tab 121 is moved closer or towards the first end of the strap 170 that is fixed to the controller body 101, e.g. the tip of the handle portion 112. Accordingly, based on the above example, according to various embodiments, the movable tab 121 at the first position may correspond to a first tautness of the strap 170. On the other hand, the movable tab 121 at the second position may correspond to a second tautness of the strap 170. Said first tautness (or degree of the first tautness) may be greater than said second tautness (or degree of the second tautness). Accordingly, the movable tab 121 at the first position may be sized and/or shaped for a smaller-sized hand and/or suitable for gripping a hand more tightly, while the movable tab 121 at the second position may be sized and/or shaped for a larger-sized hand and/or to allow a hand to move more freely along the handle portion 112.

FIG. 1C shows a close-up view of a tab-guide 130 of the controller 100, with the movable tab 121 of the strap adjustment mechanism 120 cooperatively engaged with the tab-guide 130, according to various embodiments.

FIG. 1D shows a side view of FIG. 1C, with the movable tab 121 and the tab-guide 130 cooperatively engaged with each other, according to various embodiments.

FIG. 1E shows an exploded view of the tab-guide 130, with the movable tab 121 disengaged from the tab-guide 130, according to various embodiments.

According to various embodiments, the controller 100 may be configured in a manner such that the movable tab 121 is restricted to follow a straight or linear path as the movable tab 121 is moved between the first position and the second position (or from one of the first position and the second position to the other of the first position and the second position) relative to the controller body 101. For example, with reference to FIG. 1C, the strap adjustment mechanism 120 may include the tab-guide 130 which may define a straight or linear pathway or passageway or channel (hereafter referred to as “linear pathway” for ease of illustration) for the movable tab 121 to be movable therealong. Accordingly, the movable tab 121 may be seated along (e.g. may be movably or slidably along) the linear pathway of the tab-guide 130. The tab-guide 130 may be secured (e.g. immovably secured) or fastened to the controller body 101 (e.g. via one or more screws coupling one or more members or portions of the tab-guide 130 to the controller body 101), such that the movable tab 121 being movable (e.g. slidable) relative to the tab-guide 130 (i.e. secured or fastened to the controller body 101) may be movable relative to the controller body 101 itself. The tab-guide 130 may be configured (e.g. oriented with respect to the controller body 101) such that the linear pathway defined by the tab-guide 130 may be perpendicular to the control surface 111 (e.g. a flat control surface 111) of the controller body 101. According to various other embodiments, when each of the one or more control elements 113 is or includes a touch screen, a push button, etc., with an input axis (e.g. a central axis or an axial axis) extending across the control element 113 and/or extending perpendicularly to the control surface 111 (e.g. flat control surface 111) of the controller body 101, the tab-guide 130 may be configured such that the linear pathway defined by the tab-guide 130 may be parallel with said input axis of such a control element 113 (e.g. touch screen, push button, etc.). Additionally, according to various embodiments, the tab-guide 130 may be configured such that the linear pathway defined thereby may be extending non-perpendicularly with respect to the handle portion 112 (e.g. an elongate and/or straight handle portion 112) of the controller body 101. In other words, the handle portion 112 may be arranged such that the longitudinal axis 112a of the handle portion 112 may be extending non-perpendicularly to the linear pathway defined by the tab-guide 130. When the linear pathway and the handle portion 112 are non-perpendicularly arranged with respect to each other, as described, moving the movable tab 121 along the linear pathway, and relative to a second attachment element 182 at the handle portion 112 (described in detail later with reference to FIG. 1G), would result in a change in tautness of the strap 170 (i.e. when the strap 170 is releasably attached to the controller body 101).

According to various embodiments, with reference to FIG. 1D, the movable tab 121 may include a first engagement arrangement 161. Further, the tab-guide 130 may include a second engagement arrangement 165. The first engagement arrangement 161 and the second engagement arrangement 165 may be configured to inter-engage with each other to or for releasably holding the movable tab 121 in place relative to the tab-guide 130 at one of a plurality of positions (e.g. the first position, the second position, or an intermediate position between the first position and the second position). The first engagement arrangement 161 and the second engagement arrangement 165 may include inter-engageable protrusion(s) and recess(es), or inter-engageable magnetic couplings, or any other inter-engageable elements. As an example, with reference to FIG. 1D, according to various embodiments, the first engagement arrangement 161 may include a (or at least one) first engagement element (e.g. a protrusion or a set/group of protrusions) and the second engagement arrangement 165 may include a plurality of second engagement elements (e.g. recesses or sets/groups of recesses) configured to inter-engage with the first engagement element (e.g. configured or shaped to mate with the protrusion). According to various other embodiments (not shown), the first engagement arrangement 161 may include a plurality of first engagement elements and the second engagement arrangement 165 may include a (or at least one) second engagement element. According to various other embodiments (not shown), the first engagement arrangement 161 may include a plurality of first engagement elements and the second engagement arrangement 165 may include a plurality of second engagement elements. Referring to FIG. 1D, according to various embodiments, the plurality of second engagement elements of the second engagement arrangement 165 may include a first sub-set of the second engagement elements disposed at a first region (e.g. top or topmost region) of the tab-guide 130. The first region may be corresponding to and/or aligned (e.g. horizontally aligned, on a same plane/lateral plane, etc., when the controller 100 is in the upright orientation as shown in FIG. 1) with and/or adjacent to the first position proximal to the control surface 111 of the main portion 110 of the controller body 101. Further, according to various embodiments, the plurality of second engagement elements of the second engagement arrangement 165 may include a second sub-set of second engagement elements disposed at a second region (e.g. bottom or bottommost region), opposite the first region, e.g. along the linear pathway, of the tab-guide 130. The second region may be corresponding to and/or aligned with and/or adjacent the second position distal from the control surface 111 of the main portion 110 of the controller body 101. According to various other embodiments (not shown), the plurality of second engagement elements may further include one or more further (e.g. third, fourth, fifth, etc.) sub-set(s)) of second engagement elements respectively disposed at one or more intermediate region(s), between said first region and said second region of the tab-guide 130. Said one or more intermediate regions of the tab-guide 130 may respectively be corresponding to and/or aligned with and/or adjacent one or more intermediate positions (i.e. of the movable tab 121) between the first position and the second position. According to various embodiments, the second engagement arrangement 165 (e.g. all of the sub-sets of the plurality of second engagement elements) may be distributed along a straight line (e.g. straight reference line or axis). According to various embodiments, all of the sub-sets of the plurality of second engagement elements of the second engagement arrangement 165 may be spaced uniformly or equally apart from one another.

With reference to FIG. 1E, according to various embodiments, the tab-guide 130 may include a main member 140 (e.g. a first member) and an auxiliary member 150 (e.g. a second member). The main member 140 and the auxiliary member 150 may be, but is not limited to being, discrete (in other words, separate and/or distinct) members or components of the tab-guide 130 and/or may be, but is not limited to being, separable from the controller body 101 itself. Thus, for example, according to various other embodiments, one or both of the main member 140 and/or the auxiliary member 150 may be integral or integrally formed (e.g. integrally molded, printed, etc.) with the controller body 101.

As shown in FIG. 1E, according to various embodiments, the main member 140 may include at least two opposing and/or parallel arms 141 bounding the linear pathway for the movable tab 121. Specifically, the at least two arms 141 may be extending in an opposing and/or parallel manner to define the linear pathway. As shown, the at least two arms 141 may be elongate arms 141. Thus, the linear pathway may be parallel with the at least two arms 141. The movable tab 121 may be disposed between the at least two arms 141, and may be movable along the linear pathway between the at least two arms 141. According to various embodiments, the second engagement arrangement 165 (or all of the sub-sets of the plurality of second engagement elements of the second engagement arrangement 165) may be distributed lengthwise along an inner surface of each arm 141. Specifically, when the second engagement arrangement 165 includes the plurality of second engagement elements, each sub-set of the of the second engagement elements of the second engagement arrangement 165 may include at least two opposing (e.g. directly opposing) and/or aligned second engagement elements (i.e. a sub-set of the plurality of second engagement elements of the second engagement arrangement 165) on the inner surfaces of the at least two arms 141. As shown, the plurality of second engagement elements of the second engagement arrangement 165 may be a plurality of four recesses, of which a first sub-set of two recesses (from among the plurality of four recesses) may be disposed at the first region (e.g. top or topmost region) of the tab-guide 130 (or the main member 140 of the tab-guide 130) and a second sub-set of another two recesses (from among the plurality of four recesses) may be disposed at the second region (e.g. bottom or bottommost region) of the tab-guide 130 (or the main member 140 of the tab-guide 130).

As shown in FIG. 1E, according to various embodiments, the main member 140 (e.g. first member) of the tab-guide 130 may further include a bridge segment 142 connecting and/or adjoining and/or between the at least two arms 141. Each arm may be affixed to and/or extending from the bridge segment 142 of the main member 140 at one longitudinal end portion (e.g. a first end portion) of the arm while another opposite longitudinal end portion (e.g. a second end portion opposite the first end portion) of the arm may be displaceable (e.g. resiliently displaceable) with respect to the first end portion of the arm 141. Accordingly, each arm may function or may resemble a resilient cantilever. For example, the bridge segment 142 (e.g. only the bridge portion itself) and/or the at least two arms 141 may include a property of being resilient (in other words, flexible, or capable of bending or bowing or flexing under an external force applied on the cantilever member, and thereafter returning or biasing or springing back to its original or initial form or position after the external force is released). For example, the bridge segment 142 and/or the at least two arms 141 may include or may be made of a same resilient or flexible material and/or may be shaped to include a property of being resilient. According to various other embodiments, the entire main member 140 may include a property of being resilient. In other words, the entire main member 140 may be a resilient main member 140. For example, the bridge segment 142 and the at least two arms 141 may together be part of, or form, a leaf spring. As a non-limiting example, as shown in FIG. 1E, the bridge segment 142 may be a “U”-shaped or bracket-shaped bridge segment 142 of the main member 140. Specifically, the bridge segment 142 may include a pair of side wall portions 142a (e.g. opposing and/or parallel side wall portions 142a) and a connection portion 142b adjoining and/or between said side wall portions 142a (e.g. at first longitudinal ends of the side wall portions 142a). Said connection portion 142b of the bridge segment 142 may be perpendicular to said side wall portions 142a of the bridge segment 142. Each arm 141 of the tab-guide 130 may be affixed to and/or adjoining a second longitudinal end, opposite the first longitudinal end, of a corresponding one of said pair of side wall portions 142a of the bridge segment 142. Further, the at least two arms 141 may be parallel with said side wall portions 142a of the bridge segment 142. In this configuration, each arm together with the corresponding side wall portion 142a of the bridge segment 142 may have a “U”-shaped side profile (as shown in FIG. 1E).

With reference to FIG. 1E, the auxiliary member 150 (e.g. the second member) of the tab-guide 130 may include at least one alignment rod 151 extending along a direction parallel with the linear pathway to be capable of aligning the movable tab 121 to be within the linear pathway as the movable tab 121 is moved. According to various embodiments, the at least one alignment rod 151 may be extending alongside an entire length of or most of the length of the linear pathway (or the at least two arms 141 bounding the linear pathway). In other words, according to various embodiments, the at least one alignment rod 151 may be of an equal or similar length as the linear pathway. With reference to FIG. 1D, according to various embodiments, the at least one alignment rod 151 may coincide with the linear pathway itself (e.g. between the at least two arms 141). According to various other embodiments (not shown), the alignment rod 151 may lie outside of the linear pathway in a manner parallel with the linear pathway. The at least one alignment rod 151 may include a property of being rigid. Further, at least one end (e.g. at least one longitudinal end of the alignment rod 151) of the at least one alignment rod 151 may be affixed to a platform segment 152 of the auxiliary member 150. The platform segment 152 may, likewise to the at least one alignment rod 151, include a property of being rigid. According to various embodiments, the entire auxiliary member 150 may include a property of being rigid. In other words, the entire auxiliary member 150 may be a rigid auxiliary member 150. According to various embodiments, the platform segment 152 and the at least one alignment rod 151 may be, but is not limited to being, integrally formed (e.g. of a same material). The movable tab 121 may define at least one bore 122 (e.g. through-hole, extending across the movable tab 121 between a bottom and a top of the movable tab 121, as shown in FIG. 1E) for the at least one alignment rod 151 to be received therewithin or inserted therethrough. Thus, when the controller 100 is assembled, the at least one alignment rod 151 may be extending through the at least one bore 122 of the movable tab 121. Accordingly, as the movable tab 121 is moved (or slid) between the first position and the second position, the at least one alignment rod 151 may help align or guide the movable tab 121 to be within and/or follow a profile or the path of the linear pathway. According to various embodiments, the at least one alignment rod 151 of the auxiliary member 150 and the bore 122 of the movable tab 121 may be shaped to correspond to each other to prevent a rotation of the movable tab 121 about the at least one alignment rod 151 of the auxiliary member 150. For example, the at least one alignment rod 151 of the auxiliary member 150 and the bore 122 of the movable tab 121 may respectively include or may have a non-circular shape (e.g. square shape, triangular shape, irregular shape). As another example, as shown in FIG. 1E, the auxiliary member 150 may include at least two parallel alignment rods 151, and the movable tab 121 may include at least two bores 122 for receiving the at least two alignment rods 151. The at least two alignment rods 151 may be spaced apart from each other, and the at least two bores 122 may be correspondingly spaced apart from each other in a corresponding manner as the at least two alignment rods 151, to be capable of preventing a rotational movement of the movable tab 121 relative to the at least two alignment rods 151 of the auxiliary member 150 when the at least two alignment rods 151 are extending through the at least two bores 122.

According to various embodiments, with reference to FIG. 1E, the auxiliary member 150 of the tab-guide 130 may include one or more side walls 153 extending from the platform segment 152 of the auxiliary member 150. The platform segment 152 and the one or more side walls 153 of the auxiliary member 150 may define a receptacle space shaped to receive the main member 140 (e.g. the entire main member 140) of the tab-guide 130. Thus, when the controller 100 is assembled, the main member 140 (i.e. first member) may be seated within the receptacle space defined by the auxiliary member 150 (i.e. second member). Specifically, when the main member 140 of the tab-guide 130 includes the “U”-shaped or bracket-shaped bridge segment 142, the connection portion 142b of the bridge segment 142 of the main member 140 of the tab-guide 130 may be interfacing or facing or in register with, and/or abutting or contacting, an inner side of the platform segment 152 of the auxiliary member 150 of the tab-guide 130.

As shown in FIG. 1D, according to various embodiments, a height of an inner side of the one or more side walls 153 of the auxiliary member 150 may be equal to a height of the at least two arms 141 and/or to a height of the side wall portions 142a of the bridge segment 142 of the main member 140 of the tab-guide 130.

FIG. 1F shows a top view of the tab-guide 130 secured to the controller body 101, according to various embodiments.

According to various embodiments, the auxiliary member 150 of the tab-guide 130 may be secured (e.g. immovably secured) or fastened to the controller body 101 (e.g. via one or more screws coupling the auxiliary member 150 of the tab-guide 130 to the controller body 101), with the main member 140 of the tab-guide 130 seated and/or fitted within the receptacle space of the auxiliary member 150.

With reference to FIG. 1D and FIG. 1F, according to various embodiments, at least a portion of the platform segment 152 of the auxiliary member 150 of the tab-guide 130 may serve as stoppers to limit movement of the movable tab 121. Further, the platform segment 152 may include one or more grooves or openings 154 (e.g. alongside the portion serving as a stopper), from an inner face of the platform segment 152, for allowing a portion the movable tab 121 to pass (e.g. when the movable tab 121 is at the first position or topmost position).

According to various other embodiments (not shown), the controller 100 may include two strap adjustment mechanism 120. Accordingly, a first end of the strap 170 of the controller 100, may be attached to a first movable tab 121 of a first strap adjustment mechanism 120 and a second end of the strap 170 of the controller 100 may be attached to a second movable tab 121 of a second strap adjustment mechanism 120. According to various other embodiments (not shown), the two strap adjustment mechanisms 120 may be on a same side of the controller body 101, for example, the first strap adjustment mechanism 120 may be at the main portion 110 of the controller body 101 and the second strap adjustment mechanism 120 may be at the handle portion 112 of the controller body 101. According to various other embodiments (not shown), the two strap adjustment mechanisms 120 may be on opposite sides of the controller body 101 (e.g. directly opposite each other).

According to various other embodiments (not shown), the controller 100 may include a plurality (e.g. two, three, or more than three) of strap adjustment mechanisms 120 for a user of the controller 100 to optionally releasably attach a strap 170 to any two of the plurality of strap adjustment mechanisms 120.

According to various other embodiments (not shown), the control surface 111 may be a curved surface (e.g. a concaved-shaped surface or a convex-shaped surface).

FIG. 1G shows an exploded view of an attachment element 181 of a strap attachment arrangement 180 of the controller 100, according to various embodiments.

With reference to FIG. 1A and FIG. 1G, according to various embodiments, the controller 100 may include (e.g. further include) the strap attachment arrangement 180 for releasably attaching a strap 170 to the controller body 101. Accordingly, according to various embodiments, the strap 170, when releasably attached to the controller body 101, may be part of the controller 100. As shown in FIG. 1A and FIG. 1G, the strap attachment arrangement 180 may include an attachment element 181 (which herein may be referred to as a “first attachment element”) at the movable tab 121 of the strap adjustment mechanism 120 at the side of the controller body 101. According to various embodiments, the movable tab 121 may be at least partially housed within the controller body 101. Accordingly, the first attachment element 181 may be assessable by a user via an opening 102 (see FIG. 1B) at said side of the controller body 101. Further, with reference to FIG. 1A, the strap attachment arrangement 180 may include (e.g. optionally include) a second attachment element 182 (or another/further attachment element) at the handle portion 112 (e.g. at an end region or free end region of the handle portion 112). According to various embodiments, when the strap 170 is releasably attached to the controller body 101, the strap 170 may form a loop with the controller body 101. Specifically, the strap 170 may be releasably attached to the controller body 101 via the strap attachment arrangement 180, with a first end (e.g. end region) of the strap 170 releasably attached to the first attachment element 181 at the movable tab 121, to form a loop with the controller body 101 for looping around the user's arm. When the strap attachment arrangement 180 includes (e.g. further includes) the second attachment element 182, the strap 170 may be releasably attached to the controller body 101 via the strap attachment arrangement 180, with a first end of the strap 170 releasably attached to the first attachment element 181 at the movable tab 121 and a second end (e.g. end region) of the strap 170, opposite the first end, releasably attached to the second attachment element 182 in a manner to form a loop with the controller body 101. As an example, each of the first attachment element 181 and the second attachment element 182 may be or may include any one or more of: a clip, a clamp, a bolt and nut, a tape member secured to the movable tab 121, or any other suitable fastener(s). As an example, with reference to FIG. 1G, the first attachment element 181 at the movable tab 121 may include a tape member with a through hole. As shown, the tape member may be fastened or secured (e.g. clamped) at one end (e.g. inner end region of the tape member) to (or by) the movable tab 121. Another end (e.g. outer end region) of the tape member may be fastened to the first end of the strap 170, for example, via a bolt extending across the through-hole of the tape member and a through-hole of the strap 170, or via a clip, etc.

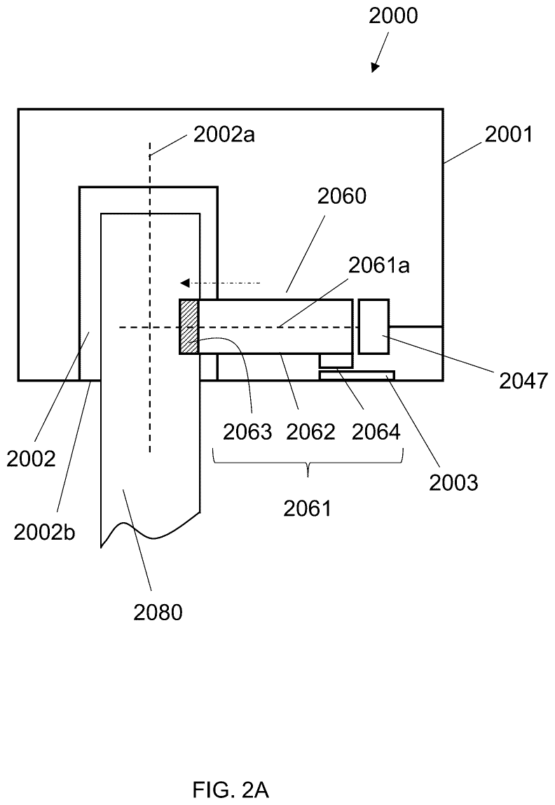

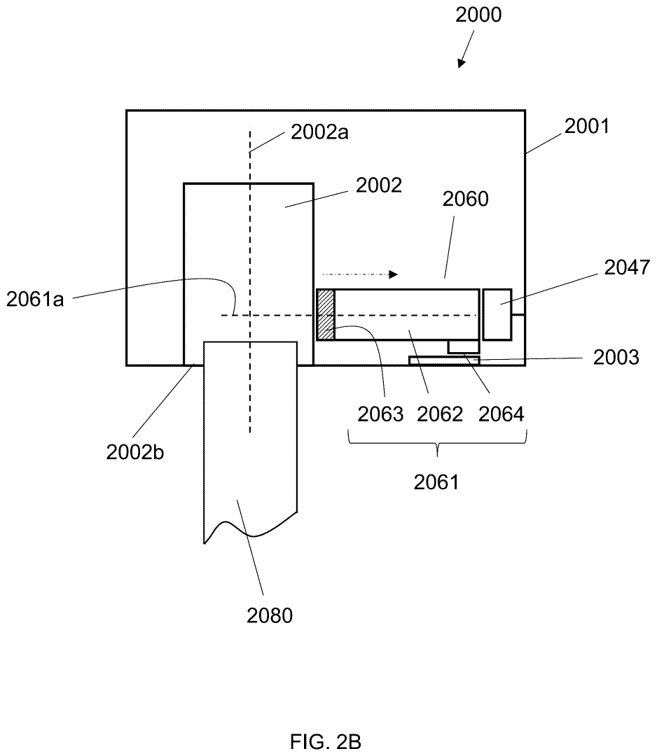

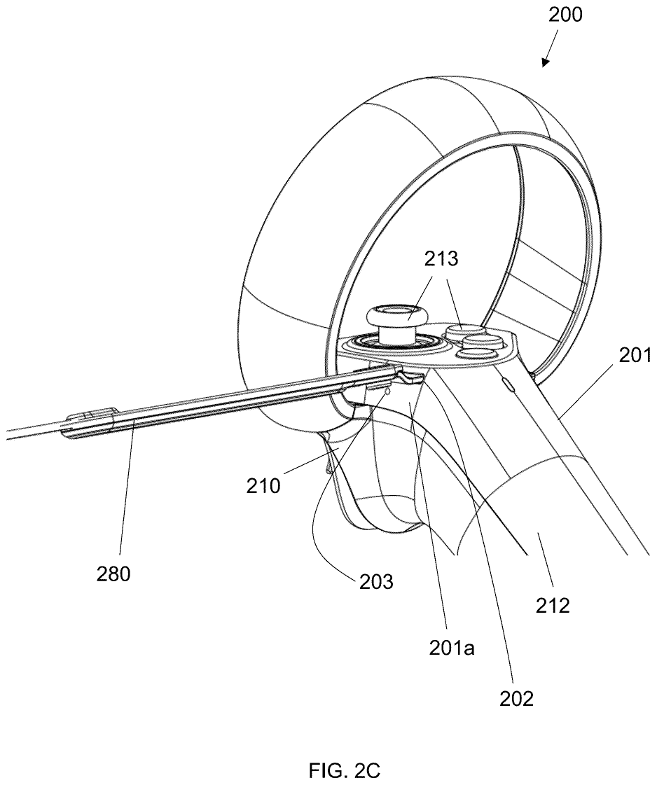

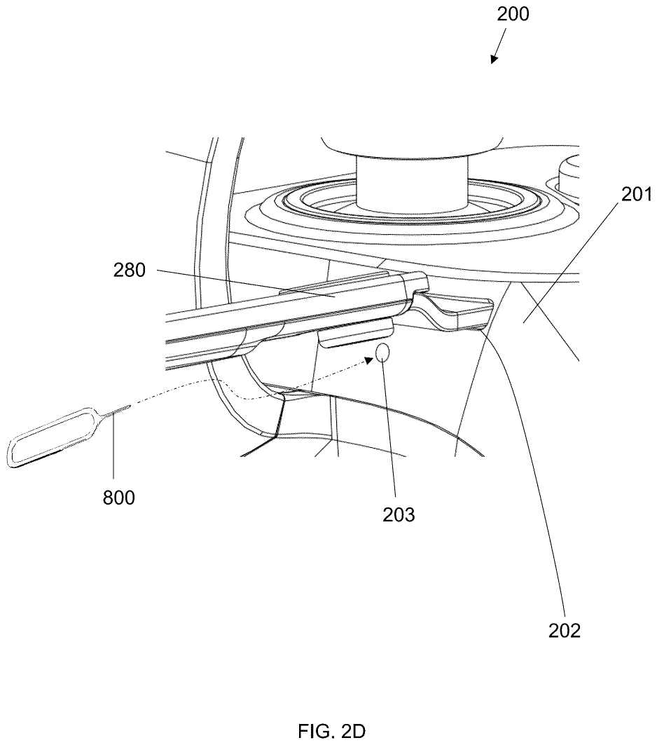

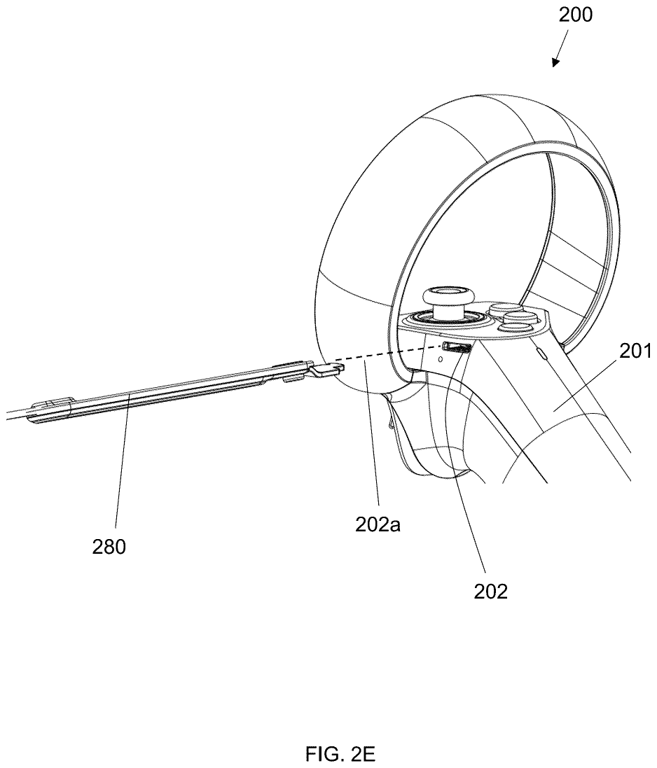

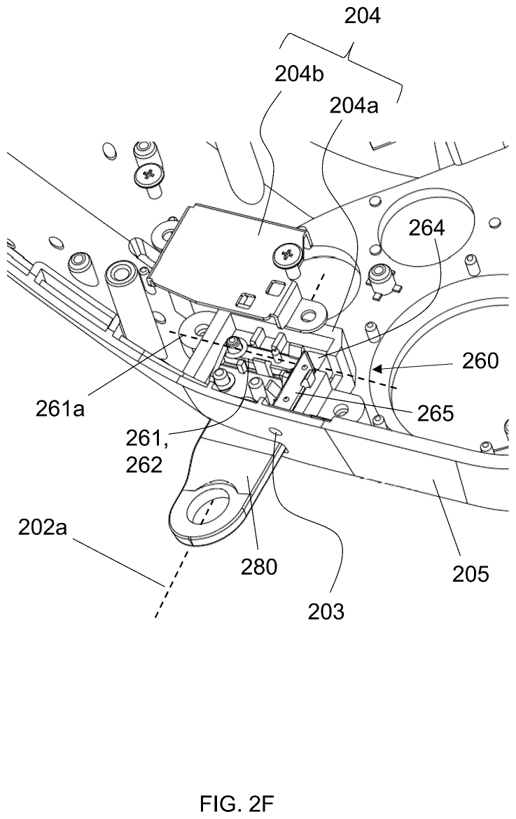

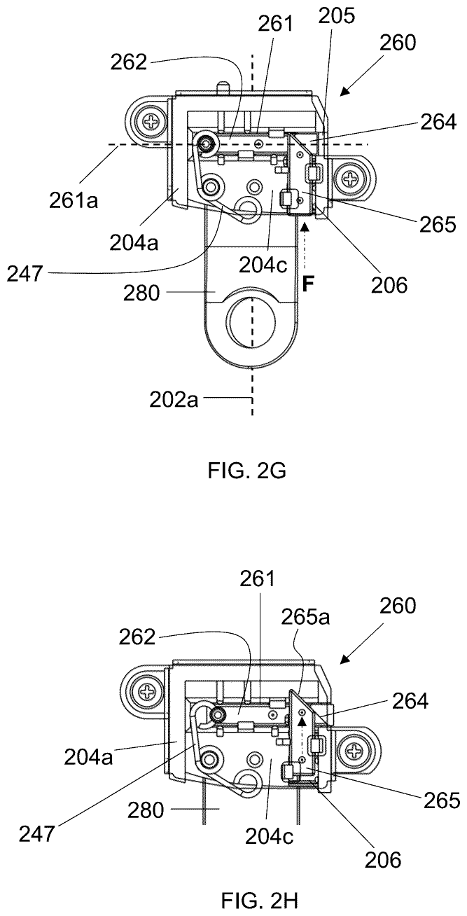

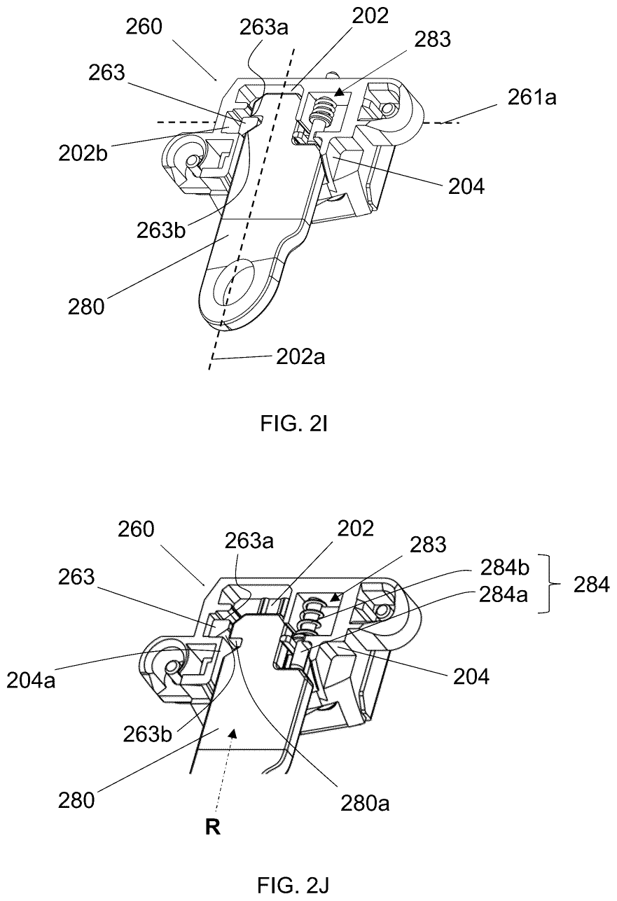

FIG. 2A shows a schematic diagram of a controller 2000 that includes a strap engagement mechanism 2060, with a displacement member 2061 of the strap engagement mechanism 2060 moved into a strap-receiving bay 2002 of the controller body 2001 to latch against a strap 2080, according to various embodiments.

FIG. 2B is a schematic diagram of the controller 2000 of FIG. 2A, with the displacement member 2061 of the strap engagement mechanism 2060 moved out of the strap-receiving bay 2002 to unlatch from the strap 2080, according to various embodiments.

With reference to FIG. 2A, the controller 2000 may include the controller body 2001. The controller body 2001 may define (e.g. include) the strap-receiving bay 2002 (e.g. a receptacle space) extending from a side (e.g. a left side, a right side, a corner, etc.) of the controller body 2001 into the controller body 2001. The strap-receiving bay 2002 may be configured (e.g. shaped and/or sized) for receiving therein the strap 2080 (e.g. a wrist strap), or at least a portion of the strap 2080, for the controller 2000. The strap-receiving bay 2002 may have an insertion axis 2002a. According to various embodiments, the insertion axis 2002a may be extending along a direction of insertion for inserting the strap 2080 into the strap-receiving bay 2002. For example, the insertion axis 2002a may be extending along a centerline of the strap-receiving bay 2002 from an entrance (e.g. an opening) 2002b of the strap-receiving bay 2002 into the controller body 2001. Accordingly, the insertion axis 2002a may be passing through a center of the entrance (e.g. an opening) 2002b of the strap-receiving bay 2002 perpendicularly into the controller body 2001. Hence, the insertion axis 2002 may be perpendicular (e.g. substantially perpendicular) to said side of the controller body 2001 at the entrance (e.g. an opening) 2002b of the strap-receiving bay 2002. According to various embodiments, the strap-receiving bay 2002 may be elongate (or longitudinally extending) along the insertion axis 2002a. With the entrance (e.g. an opening) 2002b of the strap-receiving bay 2002 located at said side of the controller body 2001, the strap 2080 may be insertable or inserted into the strap-receiving bay 2002 (i.e. the controller body 2001) along the insertion axis 2002a, from the side of the controller body 2001.

While the controller 2000 may be described with the strap-receiving bay 2002 configured to receive the strap 2080 (e.g. a wrist strap), nevertheless, it is understood that in various other embodiments, the strap-receiving bay 2002 may be configured to receive a strap attachment arrangement (e.g. similar to the strap attachment arrangement 180 of the controller 100 of FIG. 1G), instead of the strap 2080 (or a strap 280 described later, with reference to FIG. 2C), to which a strap may be attachable. Hence, the strap-receiving bay 2002 may be configured to directly receive the strap 2080 and/or indirectly receive the strap 2080 via the strap attachment arrangement 180 with the strap 2080 connected thereto. Thus, description with reference to the strap 2080 being releasably engageable with the strap engagement mechanism 2060 herein is also applicable to the strap attachment arrangement 180 being releasably engageable with the strap engagement mechanism 2060 (i.e. in the follow description, the strap attachment arrangement 180 is interchangeable with the strap 2080 with reference to description related to the engagement with the strap engagement mechanism 2060).

The controller 2000 may include (e.g. further include) the strap engagement mechanism 2060. The strap engagement mechanism 2060 may be configured to latch against the strap 2080 that is within the strap-receiving bay 2022 to secure the strap 2080 to the controller body 2001 or to allow (or enable) the strap 2080 to be releasable from the controller body 2001.

With reference to FIG. 2A and FIG. 2B, the strap engagement mechanism 2060 may include a displacement member 2061 (e.g. a movable member), with at least a strap-latching portion 2063 and an engageable element 2064. According to various embodiments, the displacement member 2061 may include (e.g. further include) a main body 2062. Each of the strap-latching portion 2063 and the engageable element 2064 of the displacement member 2061 may be formed on the main body 2062 of the displacement member 2061. For instance, the strap-latching portion 2063 and the engageable element 2064 may be discrete parts disposed at the main body 2062, which may be affixed or fixedly joined (e.g. welded) to the main body 2062. As another example, the entire displacement member 2061 (e.g. which includes the main body 2062, the strap-latching portion 2063, and the engageable element 2064) may be integrally formed. Accordingly, according to various aspect, the displacement member 2061 may be (or may be formed as) a unitary (or singular) structure (i.e. a single piece), without (in other words, free of) any movable joints (i.e. across the entire displacement member 2061). As such, any two or more element or segment or portion of the displacement member 2061 (e.g. the strap-latching portion 2063, the engageable element 2064, the main body 2062) may be immovable with respect to one another.

As an example, each of the strap-latching portion 2063, the engageable element 2064, and the main body 2062 may be made of a rigid (e.g. substantially rigid) material (e.g. a rigid or substantially rigid polymer (e.g. plastic) or polymer composite, a metal or metallic composite, rubber, ceramic, glass, etc.). Each of the strap-latching portion 2063, the engageable element 2064, and the main body 2062 may be of a same or different rigid material as/from one another. According to various embodiments, the entire displacement member 2061 may be made of a continuous piece of rigid (e.g. substantially rigid) material.

The displacement member 2061 may be disposed (e.g. movably disposed) relative to the controller body 2001 (e.g. relative to the strap-receiving bay 2002 of the controller body 2001), such that the displacement member 2061 may be movable (or displaceable) relative to the controller body 2001 (e.g. relative to the strap-receiving bay 2002 of the controller body 2001), along a movement axis 2061a. The movement axis 2061a may be a single and/or linear movement axis 2061a. According to various embodiments, the movement axis 2061a (e.g. linear movement axis 2061a) may be non-parallel to the insertion axis 2002a (e.g. a linear insertion axis 2002a) of the strap-receiving bay 2002. For example, as shown, the movement axis 2061a may be perpendicular (e.g. substantially perpendicular) to the insertion axis 2002a to form a “+” configuration. As another example (not shown), the movement axis 2061a may be at an acute angle with respect to the insertion axis 2002a to form a “X” configuration.

According to various embodiments, the controller body 2001 may include a guide element (in other words, an internal portion of the controller body 2001 may be configured in a manner) to guide and/or constraint (or restrict) the displacement member 2061 to be movable along (e.g. movable along only) the movement axis 2061a. For example, the controller body 2001 may define or include a “guide-channel” (described in detail later, with reference to FIG. 2G) extending along the movement axis 2061a. The guide-channel (i.e. guide element) may be sized and/or shaped (in other words, configured) to slidably receive the displacement member 2061 (e.g. the main body 2062 of the displacement member 2061) therein (or therealong). Accordingly, the displacement member 2061 may be slidable along the movement axis 2061a, via the guide-channel. As another example (not shown), the controller body 2001 may include an internal “guide-rod” (i.e. guide element) extending along the movement axis 2061a. The displacement member 2061 (e.g. the main body 2062 of the displacement member 2061) may be in sliding engagement with the guide-rod (e.g. such that the guide-rod is extending through a through-hole of the main body 2062). Accordingly, the displacement member 2061 may be slidable along the movement axis 2061a, via the guide-rod.

With reference to FIG. 2A and FIG. 2B, the displacement member 2061 may be movable between a first position (as shown in FIG. 2A) and a second position (as shown in FIG. 2B), relative to the strap-receiving bay 2002. When the displacement member 2061 is initially at the second position (as shown in FIG. 2B), moving the displacement member 2061 to the first position (as shown in FIG. 2A) moves the strap-latching portion 2063 of the displacement member 2061 into the strap-receiving bay 2002 (e.g. to be partially, or entirely within the strap-receiving bay 2002). In other words, in the first position (as shown in FIG. 2A), the strap-latching portion 2063 (e.g. at least or only the strap-latching portion 2063) of the displacement member 2061 may be within the strap-receiving bay 2002 for latching against the strap 2080. According to various embodiments, in the first position, the strap-latching portion 2063 may be within (e.g. extending into) a side region of the strap-receiving bay 2002. The side region of the strap-receiving bay 2002 may be a region (or segment) of the strap-receiving bay 2002 along and/or bounded and/or immediately adjacent an edge of the strap-receiving bay 2002 and within the strap-receiving bay 2002. Said edge of the strap-receiving bay 2002 may be non-perpendicular with respect to the insertion axis 2002a of the strap-receiving bay 2002. For example, said edge of the strap-receiving bay 2002 may be a longitudinally-extending edge of the strap-receiving bay 2002.

On the other hand, when the displacement member 2061 is at the first position, moving the displacement member 2061 to the second position (as shown in FIG. 2B) moves the strap-latching portion 2063 of the displacement member 2061 out of (e.g. entirely out of) and/or away from the strap-receiving bay 2002. In other words, in the second position, the strap-latching portion 2063 of the displacement member 2061 may be outside of and/or apart from the strap-receiving bay 2002. Accordingly, the strap-latching portion 2063 of the displacement member 2061 may be withdrawn from the strap-receiving bay 2002 when the displacement member 2061 is moved to the second position to be absent from the strap-receiving bay 2002. Hence, the strap-latching portion 2063 of the displacement member 2061 may be free of being present in or occupying a space within the strap-receiving bay 2002 when the displacement member 2061 is moved to the second position. With the strap-latching portion 2063 of the displacement member 2061 moved outside the strap-receiving bay 2002, the strap 2080 may be unlatched such that the strap 2080 may be readily removed (or detached) from the controller body 2001.

The strap-latching portion 2063 of the displacement member 2061 (e.g. which may be a segment or a portion of the displacement member 2061) may include a surface (herein referred to as “latching-surface”) configured to serve as a stopper against at least a portion of the strap 2080 that is in the strap-receiving bay 2002 to prevent the strap 2080 from freely slipping out of the strap-receiving bay 2002. Specifically, the latching-surface of the strap-latching portion 2063 of the displacement member 2061 may be oriented to face (or may be directed) inwards of the controller body 2001 with respect to the insertion axis 2002a (see latching-surface 263a of FIG. 2I, described in detail later), to form a catch (or a hook portion) for catching (or hooking) the portion of the strap 2080 that is in the strap-receiving bay 2002. The latching-surface may be inclined at an angle with respect to the insertion axis 2002a. For example, according to various embodiments, when the displacement member 2061 is at the first position (as shown in FIG. 2A), the strap-latching portion 2063 may be extending into a side region of the strap-receiving bay 2002, with the latching-surface of the strap-latching portion 2063 (i) oriented inwards with respect to the insertion axis 2002a, or (ii) oriented inwards and inclined with respect to the insertion axis 2002a, or (iii) oriented inwards and perpendicular with respect to the insertion axis 2002a. As another example (not shown), the latching-surface may be (i) oriented to be directed towards the insertion axis 2002a, or (ii) parallel (e.g. substantially parallel) with respect to the insertion axis 2002a, or (ii) oriented to be directed towards the insertion axis 2002a and inclined with respect to the insertion axis 2002a. In this manner, when the displacement member 2061 is at the first position, the strap-latching portion 2063 may be extending into the side region of the strap-receiving bay 2002, to press or clamp and/or impinge a portion of the strap 2080 in the strap-receiving bay 2002, e.g., against an opposite segment of the controller body 2001 (or against a component of the controller 2000 that is affixed to the controller body 2001 opposite the strap-latching portion 2063), thereby securing (e.g. holding) the strap 2080 within the strap-receiving bay 202. According to various other embodiments, the strap-latching portion 2063 may include (e.g. further/optionally include) a magnetic coupling element (for magnetically coupling to a corresponding magnetic or ferromagnetic coupling element of the strap), Velcro, adhesive, and/or resilient memory foam, or any other suitable type of fastener(s) or latching element(s).

According to various embodiments, as the displacement member 2061 may be a unitary (or singular) structure, the entire displacement member 2061 (e.g. the strap-latching portion 2063, the engageable element 2064, and the main body 2062) may be movable as a single unit along the movement axis 2061a. In other words, movement of the displacement member 2061 (e.g. the engageable element 2064 of the displacement member 2061) may result in simultaneous and/or tandem movement of an element or segment or portion of the displacement member 2061 (e.g. the strap-latching portion 2063 of the displacement member 2061 and the engageable element 2064 of the displacement member 2061).

The engageable element 2064 of the displacement member 2061 may be configured to receive an external force (e.g. applied by a user, e.g., using a tool) to move the displacement member 2061 along the movement axis 2061a. The engageable element 2064 may be or may include, for example, a slide switch, an inclined/wedge surface (for receiving the external force at an angle for moving the displacement member 2061), etc.

According to various embodiments, the displacement member 2061 may be disposed within the controller body 2001, and the controller body 2001 may include an access interface 2003 at a side of the controller body 2001 configured to provide access to the displacement member 2061 (e.g. engageable element 2064) for applying or transmitting the external force to the displacement member 2061 (e.g. engageable element 2064) to move the displacement member 2061.

As an example, the access interface 2003 may include or may be an opening (e.g. unobstructed opening, e.g., through-hole) on a side of the controller body 2001 (e.g. at the same side of the controller body 2001 where the strap-receiving bay 2002 extends inwardly from, or at a different, e.g. adjacent, side of the controller body 2001). Said opening (i.e. access interface 2003) may provide the user of the controller 2000 with access (e.g. unobstructed access) to the engageable element 2064 of the displacement member 2061 (e.g. encased within the controller body 2001). The user may insert a tool with a pointed end or pin-like feature, for example, a needle, a paper clip, staple, post of an earring, a toothpick, an eject pin/sim card eject pin, etc., into said opening (i.e. access interface 2003) to engage (e.g. press), in other words, apply the external force onto, the engageable element 2064 (encased within the controller body 2001) to move the displacement member 2061 (i.e. as a single unit) along the movement axis 2061a and relative to the strap-receiving bay 2002.

As another example, the access interface 2003 may include an intervening movable member (e.g. a plunger member) in engagement with the engageable element 2064 of the displacement member 2061. In this manner, the user may apply an external force to the intervening movable member for transmitting the external force (e.g. via the intervening movable member) to the engageable element 2064 for moving the displacement member 2061 along the movement axis 2061a and relative to the strap-receiving bay 2002.

As yet another example, the access interface 2003 may include or may be a button (e.g. push button).

As described, the engageable element 2064 of the displacement member 2061 that may be configured to receive the external force may be within the controller body 2001 (i.e. encased or hidden or concealed in the controller body 2001). According to various embodiments, the entire strap engagement mechanism 2060 may be housed within the controller body 2001 (or concealed by or contained in the controller body 2001), without any part of the strap engagement mechanism 2060 protruding from an outer surface (e.g. an outer housing) of the controller body 2001. As such, an exterior surface of the controller 2000 according to the various embodiments described may be relatively smooth to the user's touch.

With reference to FIG. 2A, according to various embodiments, the controller 2000 may include (e.g. further/optionally include) a biasing element 2047 coupled (e.g. directly or indirectly) to the controller body 2001 and to the displacement member 2061 in a manner to bias the displacement member 2061 towards the first position. For example, the biasing element 2047 may include any one or a combination of a spring (e.g. leaf spring, coil/compression spring, torsion spring, etc.), a memory foam, a resilient element (e.g. a rubber, a silicon, etc.), etc., or any other biasing element. According to various embodiments, the biasing element 2047 may be arranged in a manner such that, when the displacement member 2061 is moved from the first position (shown in FIG. 2A) to the second position (shown in FIG. 2B), the biasing element 2047 may become resiliently deformed, thereby exerting a biasing force on the displacement member 2061 to urge the displacement member 2061 toward the first position. As such, the biasing element 2047 may cause the displacement member 2061 to have the tendency to return to or to remain at the first position by “default” (e.g. when no external force is received by the engageable element 2064 of the displacement member 2061). On the other hand, simply applying the external force to the engageable element 2064 of the displacement member 2061 (e.g. with a single “push” motion or action by the user) may cause the displacement member 2061 to move from the “default” first position to the second position to “unlatched” from a strap 2080 within the strap-receiving bay 2002. At the same time, the biasing element 2047 may be resiliently deformed to be loaded for exerting the biasing force on the displacement member 2061 to urge the displacement member 2061 toward the first position as the displacement member 2061 moves from the “default” first position to the second position. As such, the controller 2000 of the various embodiments may allow for simple and quick “strap release” from the controller body 2001 (e.g. with a single “push” motion or action from a user to move the displacement member 2061 from the first position to the second position and automatic retraction of the displacement member 2061 from the second position to the first position by the biasing element 2047 upon release of the “push” motion or action from the user).

FIG. 2C shows a perspective view of a controller 200 with a controller body 201 that defines a strap-receiving bay 202, according to various embodiments.

As in the strap-receiving bay 2002 of the controller 2000 of FIG. 2A and FIG. 2B, the strap-receiving bay 202 of the controller 200 of FIG. 2C may be at a side 201a of the controller body 201 of the controller 200.

In addition, the controller 200 may, similar to the controller 100 of FIG. 1A, be configured for an electronic device. The components of controller 200 that are like the corresponding components of controller 100 of FIG. 1A and/or the controller 2000 of FIG. 2A and FIG. 2B are similarly numbered. The description of these components made with respect to controller 100 and/or the controller 2000 is also applicable with respect to controller 200, and vice versa.

As shown in FIG. 2A, the controller 200 may include the controller body 201. As in the controller body 101 of the controller 100 of FIG. 1A, the controller body 201 of the controller 200 may include a main portion 210 and a handle portion 212 extending from the main portion 210. The main portion 210 of the controller body 201 may include a control surface 211, with one or more control elements 213 at the control surface.

Although FIG. 2C to FIG. 2E illustrate only a single strap-receiving bay 202 formed at the main portion 210 of the controller body 201 and on a left side of the controller body 201, embodiments of the disclosure may include any number (e.g. two or more) of strap-receiving bay 202s formed at any portion (e.g. head portion and/or handle portion 212) of the controller body 201 and on any side (e.g. left side, right side, bottom side, top side, corner, etc.) of the controller body 201. Thus, as a non-limiting example, various other embodiments (not shown) may include a controller body 201 defining a first strap-receiving bay 202 on a left side of the controller body 201 and a second strap-receiving bay 202 on a right side of the controller body 201 (e.g. opposite the first strap-receiving bay 202).

The controller 200 may include a strap engagement mechanism 260 (see FIG. 2F) within the controller body 201. According to various embodiments, the controller 200 may include a number of strap engagement mechanism 260(s) corresponding to a number of strap-receiving bay(s) 202. Each strap engagement mechanism 260 may include a corresponding displacement member 261 that is movable relative to a corresponding strap-receiving bay 202 of each strap engagement mechanism 260.

FIG. 2D is a close-up perspective view of the side 201a of the controller body 201, according to various embodiments.

FIG. 2E is a perspective view of the controller 200 of FIG. 2C, with the strap 280 detached from the controller body 201, according to various embodiments.

With reference to FIG. 2C and FIG. 2D, the controller body 201 may include or define an access interface 203 (illustrated in FIG. 2C and FIG. 2D as an opening) on a same side of the controller body 201 having the strap-receiving bay 202. The access interface 203 may provide access to an engageable element 264 of the displacement member 261 of the strap engagement mechanism 260 of the controller 200 which may be encased within an outer housing 205 of the controller body 201 (see FIG. 2F). The access interface 203 (e.g. opening) or a hole axis of the opening (i.e. access interface 203) may be aligned with (e.g. intersecting) the engageable element 264 of the displacement member 261.

With reference to FIG. 2D, a tool 800 (e.g. an eject pin) may be inserted into the access interface 203 to reach and/or engage (or to transmit an external force to) the engageable element 264 of the displacement member 261 within the controller body 201. The external force applied to the engageable element 264 may move the entire displacement member 261 along a movement axis 261a (see FIG. 2F) between a first position and a second position (i.e. relative to the strap-receiving bay 202). More particularly, the strap-adjustment mechanism of the controller 200 may be configured such that applying the external force to the engageable element 264 (e.g. by inserting the tool 800 into the access interface 203 to engage the engageable element 264) may move the displacement member 261 to the second position (i.e. to “unlatch” from a strap 280 within the strap-receiving bay 202). Accordingly, with the displacement member 261 at the second position, the strap 280 may be readily removed (or detached) from the controller body 201 (as depicted in FIG. 2E).

FIG. 2F is an internal view of the controller body 201 of the controller 200 of FIG. 2C, revealing the strap engagement mechanism 260, according to various embodiments.

FIG. 2G and FIG. 2H are top views of the strap engagement mechanism 260 of FIG. 2F. More specifically, FIG. 2G shows the displacement member 261 of the strap engagement mechanism 260 at the first position. FIG. 2H, on the other hand, shows the displacement member 261 being moved from the first position to the second position, when an external force is applied to the engageable element 264 of the displacement member 261.

FIG. 2I and FIG. 2J are respective bottom views the strap engagement mechanism 260 of FIG. 2G and FIG. 2H.

According to various embodiments, the strap engagement mechanism 260 may include the displacement member 261, which may be movable along the movement axis 261a, between the first position (shown in FIG. 2G and FIG. 2I) and the second position (shown in FIG. 2H and FIG. 2J).

Referring to FIG. 2I, the displacement member 261 may include a strap-latching portion 263 and, referring to FIG. 2G, the displacement member 261 may include (e.g. further include) the engageable element 264. More specifically, the displacement member 261 may include a main body 262 (shown in FIG. 2G), and the strap-latching portion 263 and the engageable element 264 may be disposed at the main body 262.

The displacement member 261 may be movable along the movement axis 261a, for example, by way of engaging the engageable element 264.

As shown in FIG. 2I, when the displacement member 261 is at (or moved to) the first position, the strap-latching portion 263 may be extending (e.g. at least partially, or entirely) into the strap-receiving bay 202. More particularly, as shown, the strap-latching portion 263 may be extending (or moved) into a side region of the strap-receiving bay 202 when the displacement member 261 is at (or moved to) the first position (e.g. from the second position). On the other hand, with reference to FIG. 2J, when the displacement member 261 is at (or moved to) the second position (e.g. from the first position), the strap-latching portion 263 may be (or may be moved) outside (e.g. entirely outside) of the strap-receiving bay 202. With reference to FIG. 2I and FIG. 2J, the strap-receiving bay 202 may be shaped such that the strap 280 may occupy the entire strap-receiving bay 202 as the strap 280 is being inserted (e.g. completely) into the strap-receiving bay 202.

As shown in FIG. 2I and FIG. 2J, according to various embodiments, the strap-latching portion 263 may include (or may be formed as, or may be) an elongate portion (e.g. a post) protruding from the main body 262 (see FIG. 2F) of the displacement member 261. The elongate portion (i.e. strap-latching portion 263) may be extending perpendicularly (e.g. substantially perpendicularly) from a side of the main body 262. The main body 262 of the displacement member 261 may be positioned along (e.g. directly/exactly along or on) the movement axis 261a, with the movement axis 261a being non-parallel (e.g. perpendicular/substantially perpendicular) to the insertion axis 202a, and the elongate portion (i.e. strap-latching portion 263) may be extending in a non-parallel (e.g. perpendicular/substantially perpendicular) manner with respect to the movement axis 261a and to the insertion axis 202a. That is, as shown in FIG. 2I and FIG. 2J, the elongate portion (i.e. strap-latching portion 263) may be extending from the main body 262, in a direction along a thickness (herein referred to as “thickness-direction”) of the strap-receiving bay 202. Accordingly, when the strap 280 is within the strap-receiving bay 202, and when the displacement member 261 is at the first position (as shown in FIG. 2I), the elongate portion (i.e. strap-latching portion 263) may be extending across a thickness of the strap 280.

The strap-latching portion 263 (e.g. elongate portion) may include a strap-latching-surface 263a at a side (e.g. an inward facing, lateral side) thereof. As shown in FIG. 2I and FIG. 2J, the strap-latching-surface 263a may face (or be directed) inwards of the controller body 201 with respect to the insertion axis 202a. As a non-limiting example, the strap-latching-surface 263a may be perpendicular (e.g. substantially perpendicular) to the insertion axis 202a. The strap-latching-surface 263a may abut against a corresponding outward facing portion of the strap 280, to in turn prevent the strap 280 from moving out of the strap-receiving bay 202. As a non-limiting example, with reference to FIG. 2J, the strap 280 may include a notch 280a, and an edge of the notch 280a may correspond to said outward facing portion of the strap 280.

According to various embodiments, with reference to FIG. 2I and FIG. 2J, the strap-latching portion 263 (e.g. elongate portion) may include (e.g. further/optionally include) a sliding-surface 263b at another side (e.g. an outward facing, lateral side) of the strap-latching portion 263. For example, the sliding-surface 263b may be formed opposite the strap-latching-surface 263a. That is, while the strap-latching-surface 263a may face inwards of the controller body 201 with respect to the insertion axis 202a, the sliding-surface 263b may face outwards of the controller body 201 with respect to the insertion axis 202a. More specifically, as shown in FIG. 2I, the sliding-surface 263b may be at an angle (in other words, inclined) with respect to the insertion axis 202a and facing outwards of the controller body 201 with respect to the insertion axis 202a. As such, when the displacement member 261 is initially at the first position (as shown in FIG. 2I) and with the strap-latching portion 263 extending into (e.g. a side region of) the strap-receiving bay 202, the strap 280 that is then inserted (or pushed) into the strap-receiving bay 202 (in the direction “R” shown in FIG. 2J) may engage (or abut) the sliding-surface 263b of the strap-latching portion 263 of the displacement member 261 and consequently push (or force) the strap-latching portion 263 out of the strap-receiving bay 202 (i.e. such that the displacement member 261 is moved to the second position, as shown in FIG. 2J) such that the strap-latching portion moves out of the path of (in other words, does not obstruct) the strap 280 being inserted into the strap-receiving bay 202. When the strap 280 is completely inserted into the strap-receiving bay 202 (as shown in FIG. 2I), the strap-latching portion 263 may be moved back into the strap-receiving bay 202 (i.e. back to the first position) to latch against the strap 280.

Accordingly, as described, the controller 200 may provide a strap engagement mechanism 260 which enables fast and simple attachment of a strap 280 for the controller 200 to the controller body 201.

Referring to FIG. 2I and FIG. 2J, the strap-latching portion 263 (having the strap-latching-surface 263a and the sliding surface as described) may have a triangular or wedged shaped cross-sectional profile (e.g. when looking into the strap-latching portion 263 along its longitudinal axis). The cross-sectional profile may be uniform along the entire length of the strap-latching portion 263.

Turning back to FIG. 2G, the engageable element 264 of the displacement member 261 (e.g. opposite the strap-latching portion 263 of the displacement member 261 shown in FIG. 2I) may include or may be a surface of the displacement member 261 that is inclined (in other words, arranged or oriented to be inclined) with respect to the movement axis 261a and/or with respect to the insertion axis 202a. For instance, as shown in FIG. 2G, the engageable element 264 may be a flat or planar surface that is at an angle (in other words, inclined) with respect to the insertion axis 202a and face outwards of the controller body 201 with respect to the insertion axis 202a. Accordingly, with the displacement member 261 initially at the first position (as shown in FIG. 2G), an external force that is being applied (e.g. uniformly or continually) to the engageable element 264 (e.g. in a direction “F” shown in FIG. 2G, that may be parallel to the insertion axis 202a and/or perpendicular to the movement axis 261a,) may move the displacement member 261 towards the second position (as shown in FIG. 2H) until the displacement member 261 reaches the second position (or until the strap-latching portion 263 is out of the strap-receiving bay 202).

While FIG. 2G and FIG. 2H illustrates the engageable element 264 as being oriented in a manner to cause the displacement member 261 to move from the first position to the second position as the external force is applied onto the engageable element 264 in a direction inwards of the controller body 201, nevertheless, according to various other embodiments (not shown), the engageable element 264 may be oriented in a different or inverse manner. For example, according to various other embodiments (not shown), the engageable element 264 may be oriented in a manner to cause the displacement member 261 to move from the second position to the first position as the external force is applied onto the engageable element 264.

According to various other embodiments, instead of being a flat or planar surface, the engageable element 264 may be a contoured or curved (e.g. concave or convex shaped) surface. In this configuration, an external force that is uniformly applied to the contoured or curved engageable element 264 may lead to the displacement element being displaced (or travelling) at a non-uniform rate along the movement axis 261a.

Turning back to FIG. 2F, the engageable element 264 may include (e.g. further include) an elongate portion (e.g. a different or another elongate portion from an elongate strap-latching portion 263 described above) protruding from the main body 262 of the displacement member 261, with the flat or planar surface of the engageable element (described above) formed or being on a side (e.g. lateral side) of the elongate portion. As shown, the engageable element 264 may be extending from a side of the main body 262 and/or perpendicularly (e.g. substantially perpendicularly) to the main body 262.

With reference to FIG. 2G to FIG. 2J, as a non-limiting example, the engageable element 264 may be extending on an opposite side of the main body 262 of the displacement member 261 from the strap-latching portion 263. As shown, the engageable element 264 and the strap-latching portion 263 may be extending parallel (e.g. substantially parallel) to each other. In addition, the main body 262 (e.g. an elongate main body 262) may be extending perpendicularly (e.g. substantially perpendicularly) to each of the engageable element 264 and the strap-latching portion 263. Accordingly, the displacement member 261 may have an “+” or “T” shaped side profile (e.g. when viewed from a longitudinal end of the main body 262). According to various embodiments, the elongate main body 262 may be elongate or extending along the movement axis 261a.

With reference to FIG. 2I and FIG. 2H, the controller 200 may include (e.g. further/optionally include) a plunger member 265 (e.g. a rod or elongate body) cooperatively coupled with the engageable element 264 of the displacement member 261. The plunger member 265 may be disposed relative to the displacement member 261 in a manner such that the plunger member 265 may be movable relative to the displacement member 261. For example, the plunger member 265 may be movable along (or in) a direction that is non-parallel (e.g. perpendicular) to the movement axis 261a of the displacement member 261. As shown, the plunger member 265 may include an end portion 265a (e.g. with an end surface) shaped to correspond to a shape of the engageable element 264, such that the end portion 265a of the plunger member 265 may be substantially interfacing with (e.g. contacting) the engageable member. For instance, when the engageable element 264 includes a flat and inclined surface (as shown), the end surface of the plunger member 265 may be a corresponding flat and inclined surface, oriented in a same (or similar) orientation as the engageable element 264 with respect to the insertion axis 202a. Therefore, according to various embodiments, the end surface of the plunger member 265 may be at an angle (in other words, inclined) with respect to the insertion axis 202a and face inwards of the controller body 201 with respect to the insertion axis 202a. Accordingly, the end surface of the plunger member 265 and the engageable element 264, which are interfacing one another, may be configured to slide past and/or against each other as the external force is applied (e.g. directly applied) to the plunger member 265 (and transmitted thereby to the engageable element 264) to move the displacement member 261 along the movement axis 261a. As shown, the external force may be applied to the plunger member 265 to move the plunger member 265 in a direction perpendicular to the movement axis 261a to, thereby, cause the displacement member 261 to move from the first position (as shown in FIG. 2G) to the second position (as shown in FIG. 2H) along the movement axis 261a.

Turning back to FIG. 2F, according to various embodiments, the controller body 201 may include (e.g. optionally include) the outer housing 205 and an internal guide structure 204. According to various embodiments, the internal guide structure 204 may be affixed to the outer housing 205. For example, the internal guide structure 204 may be immovably secured (e.g. via screws, nut and bolt, etc.) to the outer housing 205. According to various other embodiments, the internal guide structure 204 and the outer housing 205 may be integrally formed (e.g. 3-D printed) or integrally molded.

The internal guide structure 204 may include an outer bracket (e.g. outer wall or border) 204a, which may be extending perpendicularly (e.g. substantially perpendicularly) to an inner surface of the outer housing 205 of the controller body 201. The internal guide structure 204 may further include a cover (e.g. cap) 204b over the outer bracket 204a.

The outer bracket 204a of the internal guide structure 204 may outline (e.g. bound or trace) a receptacle space which includes the strap-receiving bay 202 (see FIG. 2J). More specifically, the outer bracket 204a may outline a perimeter or peripheral (e.g. at least partial peripheral) of the strap-receiving bay 202. The receptacle space may further include a recess (e.g. a pocket) 202b which may be adjacent and opened to (e.g. to a side, for example, longitudinally-extending side) of the strap-receiving bay 202. In this configuration, when the displacement member 261 is at the first position (as shown in FIG. 2I), the strap-latching portion 263 may be within the strap-receiving bay 202 of the receptacle space. On the other hand, when the displacement member 261 is at the second position (or moved from the first position to the second position), the strap-latching portion 263 may be within the recess (e.g. pocket) 202b of the receptacle (or moved from the strap-receiving bay 202 to the recess 202b).

The internal guide structure 204 may be configured (e.g. further configured) to bound and/or constraint the displacement member 261 to be movable along (e.g. along only) the (e.g. single) movement axis 261a. For example, as shown in FIG. 2G, the internal guide structure 204 may further include (or define) a guide-channel 205 (i.e. guide element). The guide-channel 205 may be extending (e.g. linearly) along and surrounding the movement axis 261a. The main body 262 of the displacement member 261 may be positioned within the guide-channel 205 to be movable (e.g. slidable) along the movement axis 261a. In other words, the main body 262 of the displacement member 261 may be in sliding engagement with the guide-channel 205 (i.e. guide element).

Additionally, the internal guide structure 204 may include (e.g. further include) an auxiliary guide-channel 206 extending non-parallel (e.g. perpendicularly) to the movement axis 261a. The auxiliary guide-channel 206 may bound and/or constraint the plunger member 265 to be movable along (e.g. along only) the auxiliary guide-channel 206 (e.g. along a longitudinal axis of the auxiliary guide-channel 206). The auxiliary guide-channel 206 may be connected to the opening (i.e. access interface 203) and/or may together with the opening form a force-receiving arrangement for the engageable element 264 to receive the external force. The auxiliary guide-channel 206 and the guide-channel 205 may be in communication (e.g. opened to) each other at an intersection point or junction. The auxiliary guide-channel 206 may be extending from the opening (i.e. access interface 203) on the side 201a of the controller body 201 to the engageable element 264 of the displacement member 261, thus, being aligned with the engageable element 264 (e.g. when the displacement member 261 is at the first position and/or second position). In other words, the auxiliary guide-channel 206 may be extending between the access interface 203 and the engageable element 264. Accordingly, the external force may be transmitted to the engageable element 264 via the movable plunger member 265 along the auxiliary guide-channel 206. The plunger member 265 may be moved against the engageable element 264, for example, by poking a tool (e.g. a point end of the tool 800) against the plunger member 265.

According to various other embodiments, when the plunger member 265 is removed from the auxiliary guide-channel 206 (in other words, when the auxiliary guide-channel 206 is unobstructed), the tool 800 may be inserted into the auxiliary guide-channel 206 to directly engage the engageable element 264 at an end of the auxiliary-guide channel. The auxiliary guide-channel 206 may guide the tool 800 (e.g. operated by a user) along a straight (or shortest) path (or distance) from the access interface 203 at the side 201a of the controller body 201 to the engageable element 264.

As a non-limiting example, the internal guide structure 204 may include a partitioning member 204c between and/or separating (e.g. at least partially separating) the receptacle space from one or both of the guide-channel 205 and/or auxiliary guide-channel 206. The partitioning member 204c may be a partitioning wall extending across the outer bracket 204a of the internal guide structure 204. Further, the partitioning wall may include a window for the strap-latching portion 263 to extend therethrough into the receptacle space (i.e. which includes the strap-receiving bay 202). Thus, for example, the main body 262 may be within the guide-channel 205, while the strap-latching portion 263 may be within (e.g. partially or entirely within) the receptacle space (e.g. within the strap-receiving bay 202 or the recess of the receptacle space).

With reference to FIG. 2G, the controller 200 may include a biasing element 247 coupled to the controller body 201 and to the displacement member 261 (e.g. to the main body 262 of the displacement member 261) in a manner to bias the displacement member 261 towards the first position. As shown, the biasing element 247 may be (or may include) a spring (e.g. torsion spring) coupled at one end to the controller body 201 (e.g. to the internal guide structure 204, or the outer bracket 204a of the internal guide structure 204) and another end to the displacement member 261 (e.g. to the main body 262 of the displacement member 261). The biasing element 247 may become resiliently deformed (e.g. compressed) when the displacement member 261 is moved to the second position (as shown in FIG. 2H), thereby exerting a biasing force on the displacement member 261 to urge the displacement member 261 to the first position (in other words, to move the displacement member 261 to the first position when the external force is removed or released from the engageable element 264 of the displacement member 261).

With reference to FIG. 2I and FIG. 2J, the controller 200 may include a strap-ejection mechanism 283. The strap-ejection mechanism 283 may include a resilient arrangement 284. As an example, the resilient arrangement 284 may include any one any one or a combination of a spring (e.g. leaf spring, coil/compression spring, torsion spring, etc.), a memory foam, a resilient element (e.g. a rubber, a silicon, etc.), etc. At least a portion of the resilient arrangement 284 may be within the strap-receiving bay 202 when the strap-receiving bay 202 is free of the strap 280 and may be resiliently deformed (e.g. towards the controller body 201) when the strap 280 is inserted into the strap-receiving bay 202, to thereby exert a biasing force on the strap 280 to urge the strap 280 outwards of the strap-receiving bay 202 and away from the controller body 201. FIG. 2J illustrates the resilient arrangement 284 as include an abutting member 284a (e.g. a push-rod) coupled to a spring 284b (e.g. a coil spring). Movement of the abutting member 284a may be constrained by the controller body 201 (e.g. the internal guide structure 204 of the controller body 201), for example, such that the abutting member 284a is movable (e.g. movable only) in a direction parallel to the insertion axis 202a. The spring 284b may be coupled (e.g. fixed) to the abutting member 284a and to the controller body 201. In this configuration, the spring 284b may be compressed or stretched as the abutting member 284a moves inwards or outwards of the controller body 201, for example, along a direction parallel to the insertion axis 202a. As shown, the abutting member 284a (e.g. at least a portion of the abutting member 284a) may be within (e.g. extending into) the strap-receiving bay 202 (e.g. a topmost region and/or inward-most region of the strap-receiving bay 202 with respect to the insertion axis 202a, e.g. furthest from the side 201a of the controller body 201) when the strap 280 is not inserted into the strap-receiving bay 202 and when the spring 284b is not resiliently deformed. As the strap 280 is being inserted into the strap-receiving bay 202 (in the direction “R” shown in FIG. 2J), the strap 280 (e.g. a top end or edge of the strap) may initially engage the abutting member 284a and thereafter move the abutting member 284a further into the controller body 201 as the strap 280 is pushed further into the strap-receiving bay 202. The movement of the abutting member 284a into the controller body 201 may, in turn, cause the spring 284b to compress (or become resiliently deformed). Accordingly, when the strap 280 is completely (or fully) inserted into the strap-receiving bay 202, the compressed (or resiliently deformed) spring 284b may be exerting (e.g. transmitting via the abutting member 284a) a biasing force on (e.g. to) the strap 280 to urge the strap 280 in a direction opposite the insertion direction and away from the controller body 201. With the biasing force exerting thereon, the strap 280 would accordingly be “automatically” ejected out of the strap-receiving bay 202 by the strap-ejection mechanism 283, when the displacement member 261 of the strap-engagement mechanism is moved to (or is at) the second position to “unlatch” from the strap 280.

According to various embodiments, the controller 200 may include the strap 280 (as described) inserted into the strap-receiving bay 202. Accordingly, when the displacement member 261 is moved to the first position, the strap-latching portion 263 of the displacement member 261 may be moved into the strap-receiving bay 202 to latch against an engagement-portion (e.g. outward facing portion) of the strap 280 that is within the strap-receiving bay 202 to thereby prevent the strap 280 from moving out of the strap-receiving bay 202. As shown in FIG. 2J, the strap 280 may include or define the notch 280a extending inwardly from a longitudinally extending side of the strap 280. A shape of the notch 280a (e.g. when looking at strap 280 along the thickness-direction) may correspond to (e.g. match) a shape (e.g. the cross-sectional profile) of the strap-latching portion 263. Accordingly, when the displacement member 261 is at the first position, the strap-latching portion 263 may be seated within (or positioned within and/or extending across) the notch 280a of the strap 280 to prevent the strap 280 from moving along the insertion axis 202a.

While the disclosure has been particularly shown and described with reference to specific embodiments, it should be understood by those skilled in the art that various changes, modification, variation in form and detail may be made therein without departing from the scope of the disclosure as defined by the appended claims. The scope of the disclosure is thus indicated by the appended claims and all changes which come within the meaning and range of equivalency of the claims are therefore intended to be embraced.

1. A controller comprising:
a controller body comprising
a main portion, and
a handle portion extending from the main portion;
one or more control elements arranged at a control surface of the main portion;
a strap adjustment mechanism at a side of the controller body, the strap adjustment mechanism comprising a movable tab that is movable between a first position proximal to the control surface of the main portion of the controller body and a second position distal from the control surface of the main portion of the controller body.

2. The controller as claimed in claim 1, further comprising:
a strap;
wherein the controller body further comprises a strap attachment arrangement for releasably attaching the strap to the controller body;
wherein the strap attachment arrangement comprises an attachment element at the movable tab of the strap adjustment mechanism;
wherein the strap is releasably attached to the controller body via the strap attachment arrangement, with a first end of the strap releasably attached to the attachment element at the movable tab, to form a loop with the controller body;
wherein, moving the movable tab between the first position and the second position changes a tautness of the strap releasably attached to the controller body.

3. (canceled)

4. The controller as claimed in claim 1,
wherein the strap adjustment mechanism comprises a tab-guide which defines a linear pathway for the movable tab to be movable therealong.

5. (canceled)

6. (canceled)

7. (canceled)

8. (canceled)

9. (canceled)

10. The controller as claimed in claim 4,
wherein the tab-guide comprises a main member with at least two opposing arms, wherein the at least two opposing arms extend in a parallel manner to define the linear pathway;
wherein the movable tab is movable along the linear pathway between the at least two opposing arms.

11. The controller as claimed in claim 1,
wherein the strap adjustment mechanism comprises a tab-guide which defines a linear pathway for the movable tab to be movable therealong;
wherein the tab-guide comprises a main member with at least two opposing arms, wherein the at least two opposing arms extend in a parallel manner to define the linear pathway;
wherein the movable tab is movable along the linear pathway between the at least two opposing arms;
wherein the movable tab comprises a first engagement element;
wherein the tab-guide comprises a plurality of second engagement elements configured to inter-engage with the first engagement element;
wherein the plurality of second engagement elements are distributed lengthwise along an inner surface of each of the at least two opposing arms.

12. (canceled)

13. (canceled)

14. (canceled)

15. The controller as claimed in claim 1,
wherein the handle portion and the main portion of the controller body are integrally formed.

16. (canceled)

17. (canceled)

18. The controller as claimed in claim 1,
wherein the movable tab is at least partially housed within the controller body via the opening.

19. A controller comprising:
a controller body including a strap-receiving bay extending from a side of the controller body into the controller body, the strap-receiving bay having an insertion axis, wherein a strap for the controller body is insertable into the strap-receiving bay along the insertion axis; and
a strap engagement mechanism comprising a displacement member with a strap-latching portion, wherein the displacement member is disposed relative to the strap-receiving bay in a manner so as to be movable along a movement axis, the movement axis being non-parallel to the insertion axis of the strap-receiving bay, between a first position and a second position,
wherein moving the displacement member from the second position to the first position moves the strap-latching portion of the displacement member into the strap-receiving bay,
wherein moving the displacement member from the first position to the second position moves the strap-latching portion of the displacement member out of the strap-receiving bay,
wherein the displacement member further comprises an engageable element configured to receive an external force to move the displacement member along the movement axis.

20. The controller as claimed in claim 19,
wherein the strap-latching portion comprises a latching-surface, the latching-surface serving as a stopper against a portion of the strap to prevent the strap from slipping out of the strap-receiving bay, when the strap is inserted into the strap-receiving bay and when the displacement member is at the first position.

21. The controller as claimed in claim 19,
wherein the latching-surface is oriented to face inwards of the controller body with respect to the insertion axis.

22. The controller as claimed in claim 20,
wherein the strap-latching portion is formed as an elongate portion protruding from a main body of the displacement member, with the latching-surface being on a side of the strap-latching portion.

23. The controller as claimed in claim 19,
wherein the strap-latching portion is moved into a side region of the strap-receiving bay when the displacement member is moved to the first position.

24. The controller as claimed in claim 19,
wherein the strap-latching portion comprises a sliding-surface to which the strap engages when strap is inserted into the strap-receiving bay, the sliding-surface being inclined with respect to the insertion axis and is oriented to face outwards of the controller body.

25. The controller as claimed in claim 19,
wherein the engageable element is a surface of the displacement member that is inclined with respect to the insertion axis and faces in a direction outwards of the controller body with respect to the insertion axis.

26. The controller as claimed in claim 19,
wherein the controller body comprises an access interface on the side of the controller body for applying the external force to the engageable element of the displacement member.

27. The controller as claimed in claim 19, further comprising:
a plunger member disposed relative to the displacement member and cooperatively coupled with the engageable element of the displacement member so as to be capable of transmitting the external force to the engageable element of the displacement member when the external force is applied to the plunger member.

28. (canceled)

29. (canceled)

30. (canceled)

31. (canceled)

32. The controller as claimed in claim 19,
wherein the controller body comprises an internal guide structure affixed to an outer housing of the controller body, the internal guide structure configured to guide the displacement member to be movable along the movement axis.

33. (canceled)

34. (canceled)

35. The controller as claimed in claim 19, further comprising:
a biasing member coupled to the controller body and to the displacement member in a manner such that the displacement member, when moved to second position from the first position, causes the biasing member to be resiliently deformed to thereby exert a biasing force on the displacement member to urge the displacement member towards the first position.

36. The controller as claimed in claim 19, further comprising:
a strap-ejection mechanism comprising a resilient arrangement,
wherein at least a portion of the resilient arrangement is within the strap-receiving bay when the strap-receiving bay is free of the strap and is resiliently deformed towards the controller body, when the strap is inserted into the strap-receiving bay, to thereby exert a biasing force on the strap to urge the strap away from the controller body.

37. The controller as claimed in claim 19, further comprising:
the strap inserted into the strap-receiving bay;
wherein, when the displacement member is moved to the first position, the strap-latching portion of the displacement member is moved into the strap-receiving bay to latch against an engagement-portion of the strap within the strap-receiving bay to thereby prevent the strap from moving out of the strap-receiving bay.

38. (canceled)
